(19) United States
(12) Patent Application Publication
(10) Pub. No.: US 2026/0163767 A1
(43) Pub. Date: Jun. 11, 2026

(54) STORAGE DEVICE, OPERATION METHOD OF STORAGE DEVICE, AND STORAGE SYSTEM INCLUDING STORAGE DEVICE

(71) Applicant: Samsung Electronics Co., Ltd., Suwon-si (KR)

(72) Inventors: Jaehwan Lim, Suwon-si (KR); Yoonyoung Kang, Suwon-si (KR); Heedong Kim, Suwon-si (KR); Hojun Shim, Suwon-si (KR); Hyunjung Yoo, Suwon-si (KR); Jungwoo Lee, Suwon-si (KR); Joon Kyu Jeong, Suwon-si (KR)

(73) Assignee: Samsung Electronics Co., Ltd., Suwon-si (KR)

(21) Appl. No.: 19/319,200

(22) Filed: Sep. 4, 2025

(30) Foreign Application Priority Data
Dec. 10, 2024 (KR) 10-2024-0182745

(51) Int. Cl. H04L 25/03; G06F 1/20

(52) U.S. Cl. CPC H04L 25/03885; G06F 1/206

(57) ABSTRACT

A storage device includes a nonvolatile memory device, and a storage controller configured to control the nonvolatile memory device. The storage controller includes a receiver configured to receive a receive signal from an external device through a first signal line, a temperature sensor configured to sense a temperature of the storage device and to output temperature information, and receiver control logic configured to adjust a setting value of the receiver, based on the temperature information.

### CROSS-REFERENCE TO RELATED APPLICATIONS

This application claims priority under 35 U.S.C. § 119 to Korean Patent Application No. 10-2024-0182745 filed on Dec. 10, 2024, in the Korean Intellectual Property Office, the disclosures of which are incorporated by reference herein in their entireties.

### BACKGROUND

Some example embodiments relate to a semiconductor memory, and more particularly, relate to a storage device, an operation method of the storage device, and/or a storage system including the storage device.

A semiconductor memory is classified as a volatile memory, which loses data stored therein when a power is turned off, such as a static random access memory (SRAM) or a dynamic random access memory (DRAM). A semiconductor memory may also be classified as a nonvolatile memory, which retains data stored therein even when a power is turned off, such as a flash memory, a phase-change RAM (PRAM), a magnetic RAM (MRAM), a resistive RAM (RRAM), or a ferroelectric RAM (FRAM).

A flash memory is being widely used as a high-capacity storage medium. A storage device including a flash memory operates under control of a host. The storage device and the host communicate with each other through various interfaces. As an example, the storage device and the host may communicate based on an NVMe (NonVolatile Memory express) which is based on PCIe (Peripheral Component Interconnection express). The PCIe may provide a high-speed serial communication. The storage device and the host communicate with each other based on specifications defined in the PCIe standard or the NVMe standard. An operation temperature of the storage device may increase depending on various operation environments of the storage device. In this case, the quality of communication between the storage device and the host may be reduced.

### SUMMARY

Some example embodiments may provide a storage device having improved reliability and/or improved performance by adjusting a setting value of a receiver included in the storage device depending on a temperature of the storage device, an operation method of the storage device, and/or a storage system including the storage device.

According to some example embodiments, a storage device includes a nonvolatile memory device, and a storage controller configured to control the nonvolatile memory device. The storage controller includes a receiver configured to receive a receive signal from an external device through a first signal line, a temperature sensor configured to sense a temperature of the storage device and to output temperature information, and receiver control logic configured to adjust a setting value of the receiver to an adjusted setting value, based on the temperature information.

Alternatively or additionally, an operation method of a storage device includes setting a receiver with a default setting value, the receiver receiving a receive signal from an external device through a first signal line, monitoring a temperature of the storage device, and adjusting a setting value of the receiver in response to the temperature of the storage device being greater than or equal to a reference value.

Alternatively or additionally according to some example embodiments, a storage device includes a nonvolatile memory device, and a storage controller configured to control the non-volatile memory device. The storage controller is configured to configure a receiver with a default setting value, the receiver being configured to receive a receive signal from an external device through initialization with the external device. In response to a temperature of the storage device exceeding a reference temperature, the storage controller is configured to re-configure the receiver based on a first setting value corresponding to a temperature of the storage device.

Alternatively or additionally according to some example embodiments, a storage system includes a host device, a first storage device that includes a first receiver configured to receive a first transmit signal from the host device through a first signal line, and a second storage device that includes a second receiver configured to receive a second transmit signal from the host device through a second signal line. In response to a first temperature of the first storage device exceeding a reference temperature, the host device is configured to perform first link retraining on the first storage device, the first link retraining adjusting a first setting value of the first receiver. In response to a second temperature of the second storage device exceeding the reference temperature, the host device is configured to perform second link retraining on the second storage device, the second link retraining adjusting a second setting value of the second receiver.

### BRIEF DESCRIPTION OF THE FIGURES

The above and other objects and features of inventive concepts will become apparent by describing in detail some example embodiments thereof with reference to the accompanying drawings.

FIG. 1 is a block diagram illustrating a system according to some example embodiments.

FIG. 2 is a diagram for describing 0-th and first physical layers of FIG. 1.

FIG. 3 is a graph for describing a characteristic according to a temperature change of a first receiver of FIG. 2.

FIG. 4 is a flowchart illustrating an operation of a storage device of FIG. 1.

FIG. 5 is a block diagram illustrating a first receiver of FIG. 2 in detail.

FIG. 6 is a diagram for describing an operation of a receiver control logic of FIG. 5.

FIG. 7 is a flowchart illustrating an operation of a storage device of FIG. 1.

FIG. 8 is a diagram for describing operation S230 of FIG. 7.

FIG. 9 is a flowchart illustrating an operation of a storage device of FIG. 1.

FIG. 10 is a flowchart illustrating an operation of a storage device of FIG. 1.

FIGS. 11 and 12 are diagrams for describing an operation of receiver control logic of FIG. 2.

FIG. 13 is a block diagram illustrating a system according to some example embodiments.

FIG. 14 is a flowchart illustrating an operation of a host of FIG. 13.

FIG. 15 is a diagram illustrating a hierarchical structure of a host and a storage device of FIG. 13.

FIG. 16 is a flowchart illustrating a link retraining operation of a host device and a storage device of FIG. 13.

FIG. 17 is a diagram for describing an operation of phase 2 of FIG. 16.

FIG. 18 is a block diagram illustrating a system according to some example embodiments.

FIG. 19 is a block diagram illustrating a system according to some example embodiments.

FIG. 20 is a block diagram illustrating a host-storage system according to some example embodiments.

FIG. 21 is a diagram illustrating a data center to which a memory device according to some example embodiments is applied.

FIG. 22 is a block diagram illustrating an electronic system according to some example embodiments.

### DETAILED DESCRIPTION

Below, some example embodiments will be described in detail and clearly to such an extent that an ordinary one in the art easily carries out the present disclosure.

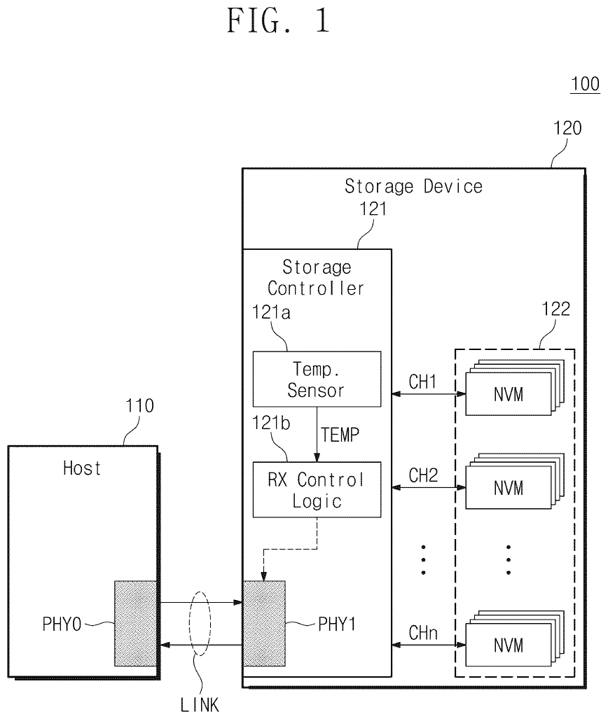

FIG. 1 is a block diagram illustrating a system according to some example embodiments. Referring to FIG. 1, a system 100 may include a host 110 and a storage device 120. In some example embodiments, the system 100 may include at least one of various information processing devices such as a personal computer, a laptop computer, a server, a workstation, a smartphone, and a tablet PC. Alternatively or additionally, the system 100 may be or may include a system which is included in an automotive device such as one or more of a navigation system, a black box (e.g., a black box flight recorder such as a flight data recorder and/or a cockpit voice recorder), or an automotive electronic device and/or includes a high-capacity storage medium included therein. Alternatively or additionally, the system 1000 may be or may include, or be included in a data center configured to store and manage various data or a storage server or an application server included in the data center.

The host 110 may be configured to control the storage device 120. For example, the host 110 may store data in the storage device 120 and/or may read data stored in the storage device 120.

The storage device 120 may operate under control of the host 110. For example, the storage device 120 may include a storage controller 121 and a plurality of nonvolatile memories 122. The storage controller 121 may store data in the plurality of nonvolatile memories 122 under control of the host 110. Alternatively or additionally, under control of the host 110, the storage controller 121 may read data stored in the plurality of nonvolatile memories 122 and may transmit the read data to the host 110.

In some example embodiments, through a plurality of channels CH1 to CHn, the storage controller 121 may communicate with the plurality of nonvolatile memories 122 or may control the plurality of nonvolatile memories 122. In some example embodiments, each of the plurality of nonvolatile memories 122 may be or may include a NAND flash memory, but example embodiments are not limited thereto.

In some example embodiments, each of the plurality of nonvolatile memories 122 may have the same electrical and/or physical characteristics such as but not limited to one or more of size, operation speed, storage capacity; however, example embodiments are not limited thereto. In some example embodiments, at least one of the plurality of nonvolatile memories 122 may have a different one of a physical and/or electrical characteristic than at least another of the plurality of nonvolatile memories 122.

In some example embodiments, the host 110 and the storage device 120 may communicate with each other based on an interface protocol, such as a dynamically determined (or, alternative, preset) interface protocol. In some example embodiments, the interface protocol may include an NVMe (Nonvolatile Memory express) interface, but example embodiments are not limited thereto. In some example embodiments, the NVMe interface may provide communications which are based on a physical layer complying with the PCIe (Peripheral Component Interconnection express) protocol. For example, the host 110 may include a 0-th physical layer PHY0, and the storage controller 121 of the storage device 120 may include a first physical layer PHY1. The 0-th and first physical layers PHY0 and PHY1 may be physically connected to each other through a communication link. Each of the 0-th and first physical layers PHY0 and PHY1 may be configured to provide the high-speed serial communication. In some example embodiments, each of the 0-th and first physical layers PHY0 and PHY1 may include a transmitter and a receiver. The transmitter of the 0-th physical layer PHY0 may transmit a signal to the receiver of the first physical layer PHY1, and the transmitter of the first physical layer PHY1 may transmit a signal to the receiver of the 0-th physical layer PHY0.

In some example embodiments, the 0-th and first physical layers PHY0 and PHY1 may accomplish an improved or optimized communication environment through an initialization operation. For example, the 0-th and first physical layers PHY0 and PHY1 may perform link equalization (EQ) and link training defined in the PCIe standard. Through the link EQ and the link training, the quality of signals which are exchanged between the 0-th and first physical layers PHY0 and PHY1 may be improved.

In some example embodiments, the link EQ and the link training described above are performed in the initialization operation on the storage device 120. For example, the link EQ and the link training are performed at a specific temperature (e.g., a room temperature). This may indicate that the 0-th and first physical layers PHY0 and PHY1 are improved or optimized at the specific temperature (e.g., a room temperature). After the initialization of the storage device 120, the temperature of the storage device 120 may change depending on various factors (e.g., an operation of the storage device 120 and/or a temperature change according to a cooling manner included in the system 100). When the temperature of the storage device 120 changes, an operation characteristic of the receiver included in the first physical layer PHY1 of the storage device 120 may change. In this case, the magnitude of a margin (e.g., a data eye) of a signal received through the receiver of the first physical layer PHY1 may decrease. According to the above description, the signal quality and/or the signal reliability of signals received by the storage device 120 may be reduced.

According to some example embodiments, the storage device 120 may control the operation characteristic of the receiver included in the first physical layer PHY1 depending on a temperature change of the storage device 120. For example, the storage controller 121 of the storage device 120 may include a temperature sensor 121a and receiver control logic 121b. The temperature sensor 121a may be configured to sense a temperature of the storage device 120 and to output temperature information TEMP corresponding to the sensed temperature. For convenience, the description is given as the temperature sensor 121a senses the temperature of the storage device 120, but example embodiments are not limited thereto. For example, the temperature sensor 121a may be configured to sense a temperature of at least one of the storage controller 121 and the nonvolatile memories 122. For example, the temperature of the storage device 120 may include a temperature of at least one of the storage controller 121 and the nonvolatile memories 122.

The receiver control logic 121b may receive the temperature information TEMP from the temperature sensor 121a. The receiver control logic 121b may determine whether the temperature of the storage device 120 changes, based on the temperature information TEMP. When the temperature of the storage device 120 changes and/or when the temperature of the storage device 120 is out of a specific range (e.g., a room temperature range), the receiver control logic 121b may control a setting value of the receiver included in the first physical layer PHY1. In some example embodiments, the setting value of the receiver may include an amplification gain value for an amplification gain of an amplifier included in the receiver. In this case, even though the temperature of the storage device 120 changes, an effective margin of the receiver included in the first physical layer PHY1 may be secured.

As described above, according to some example embodiments, the storage device 120 may secure or may be more likely to secure the effective margin of the receiver by controlling the setting value of the receiver included in the first physical layer PHY1. A configuration and an operation of the storage device 120 according to some example embodiments will be described in detail with reference to the following drawings.

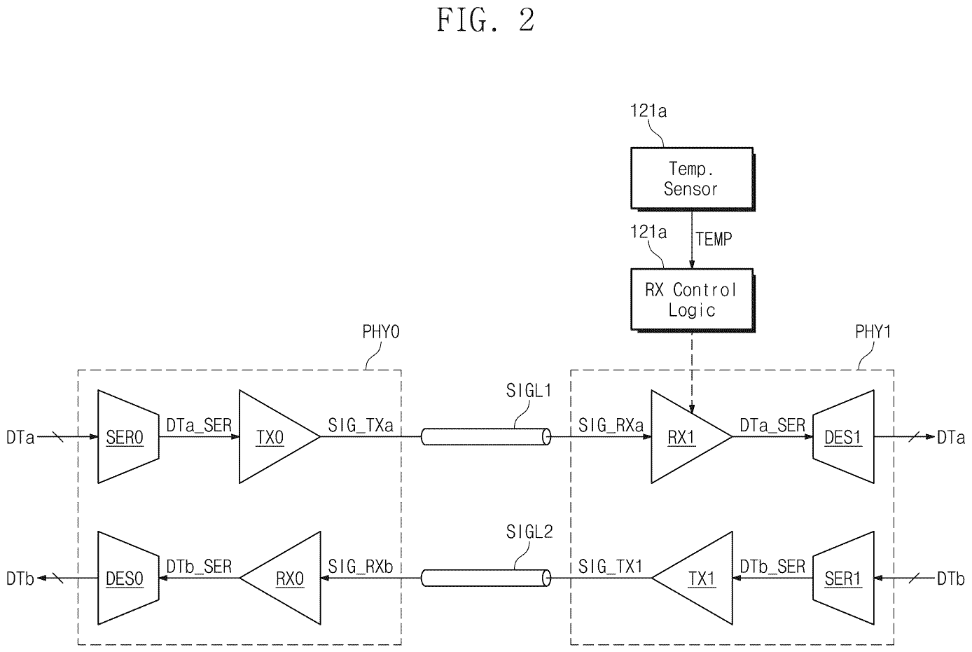

FIG. 2 is a diagram for describing the 0-th and first physical layers PHY0 and PHY1 of FIG. 1. For convenience of description, components which are unnecessary to describe the 0-th and first physical layers PHY0 and PHY1 are omitted.

Referring to FIGS. 1 and 2, the host 110 may include the 0-th physical layer PHY0, and the storage controller 121 of the storage device 120 may include the first physical layer PHY1. The 0-th physical layer PHY0 may include a 0-th serializer SER0, a 0-th transmitter TX0, a 0-th receiver RX0, and a 0-th deserializer DES0. The first physical layer PHY1 may include a first receiver RX1, a first deserializer DES1, a first serializer SER1, and a first transmitter TX1.

The host 110 may transmit a-th data DTa to the storage device 120. For example, the 0-th serializer SER0 of the host 110 may be configured to serialize the a-th data DTa to output a-th serialization data DTa_SER. The 0-th transmitter TX0 may output a-th transmit signal SIG_TXa to a first signal line SIGL1 based on the a-th serialization data DTa_SER. The first signal line SIGL1 may be connected to the first receiver RX1. For brevity of drawing and for convenience of description, there is illustrated an embodiment in which one first signal line SIGL1 is provided, but example embodiments are not limited thereto. For example, the 0-th transmitter TX0 and the first receiver RX1 may operate based on a differential signal; in this case, the 0-th transmitter TX0 and the first receiver RX1 may be connected to each other through two signal lines.

The first receiver RX1 may receive an a-th receive signal SIG_RXa through the first signal line SIGL1. In some example embodiments, the a-th receive signal SIG_RXa may correspond to a sum of the a-th transmit signal SIG_TXa and a noise due to the first signal line SIGL1. The first receiver RX1 may sample the a-th receive signal SIG_RXa to output the a-th serialization data DTa_SER. The first deserializer DES1 may deserialize the a-th serialization data DTa_SER to output the a-th data DTa. Through the above operation, the host 110 may transmit the a-th data DTa to the storage device 120.

The storage device 120 may transmit b-th data DTb to the host 110. For example, the first serializer SER1 of the storage device 120 may be configured to serialize the b-th data DTb to output b-th serialization data DTb_SER. The first transmitter TX1 may output a b-th transmit signal SIG_TXb to a second signal line SIGL2 based on the b-th serialization data DTb_SER. The second signal line SIGL2 may be connected to the second receiver RX2. For brevity of drawing and for convenience of description, there is illustrated example embodiments in which one second signal line SIGL2 is provided, but example embodiments are not limited thereto. For example, the first transmitter TX1 and the 0-th receiver RX0 may operate based on a differential signal; in this case, the first transmitter TX1 and the 0-th receiver RX0 may be connected to each other through two signal lines.

The 0-th receiver RX0 may receive a b-th receive signal SIG_RXb through the second signal line SIGL2. In some example embodiments, the b-th receive signal SIG_RXb may correspond to a sum of the b-th transmit signal SIG_TXb and a noise due to the second signal line SIGL2. The 0-th receiver RX0 may sample the b-th receive signal SIG_RXb to output the b-th serialization data DTb_SER. The second deserializer DES2 may deserialize the b-th serialization data DTb_SER to output the b-th data DTb. Through the above operation, the storage device 120 may transmit the b-th data DTb to the host 110.

In some example embodiments, the 0-th and first transmitters TX0 and TX1 and the 0-th and first receivers RX0 and RX1 included in the 0-th and first physical layers PHY0 and PHY1 may include equalizers for removing or canceling out the noises due to the first and second signal lines SIGL1 and SIGL2. For example, the 0-th transmitter TX0 may include a feed forward equalizer (FFE), the first receiver RX1 may include a continuous time linear equalizer (CTLE) and/or a decision feedback equalizer (DFE). The a-th serialization data DTa_SER may be normally sampled from the a-th receive signal SIG_RXa through the feed forward equalizer, the continuous time linear equalizer, and the decision feedback equalizer of the 0-th transmitter TX0 and the first receiver RX1.

In some example embodiments, setting values of the feed forward equalizer, the continuous time linear equalizer, and the decision feedback equalizer of the 0-th transmitter TX0 and the first receiver RX1 may be configured through the link EQ and the link training described with reference to FIG. 1. In this case, as described above, when the temperature of the storage device 120 changes, one or more operation characteristics of the first receiver RX1 may change, thereby making it difficult or impossible to normally sample the a-th serialization data DTa_SER from the a-th receive signal SIG_RXa.

The receiver control logic 121b may receive the temperature information TEMP from the temperature sensor 121a and may determine whether the temperature of the storage device 120 changes, based on the received temperature information TEMP. When the temperature of the storage device 120 changes, the receiver control logic 121b may control the setting value of the first receiver RX1. In some examples, the receiver control logic 121b may control an amplification gain associated with the continuous time linear equalizer included in the first receiver RX1. Alternatively or additionally, the receiver control logic 121b may control the setting values of the continuous time linear equalizer and the decision feedback equalizer included in the first receiver RX1. In this case, even though the temperature of the storage device 120 changes, an effective margin of the first receiver RX1 may be secured.

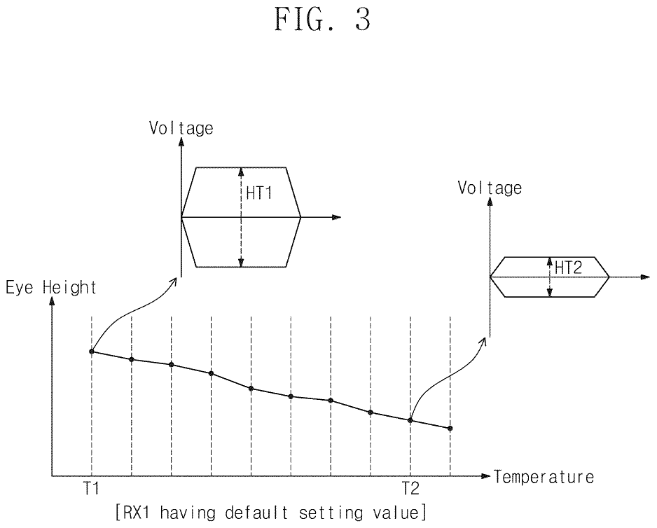

FIG. 3 is a graph for describing a characteristic according to a temperature change of a first receiver of FIG. 2. In FIG. 3, the horizontal axis represents a temperature of the storage device 120, and the vertical axis represents a height of a data eye of a signal input to the first receiver RX1. In some example embodiments, the height of the data eye may indicate a margin or an effective margin of a signal.

The graph of FIG. 3 shows an operation characteristic of the first receiver RX1 having a default setting value. The default setting value may indicate a setting value configured in the first receiver RX1 through the link EQ and the link training in the initialization operation of the storage device 120. For example, the default setting value may indicate a setting value at which the first receiver RX1 operates in a good or an optimal state at a specific temperature (e.g., a room temperature).

As illustrated in FIG. 3, as the temperature of the storage device 120 increases, the height of the data eye of the signal received by the first receiver RX1 may decrease. For example, at a first temperature T1, the data eye of the signal received by the first receiver RX1 may have a first height HT1. In contrast, at a second temperature T2 higher than the first temperature T1, the data eye of the signal received by the first receiver RX1 may have a second height HT2 lower than the first height HT1. This indicates that as the temperature of the storage device 120 increases, the operation characteristic of the first receiver RX1 is degraded. In other words, as the temperature of the storage device 120 increases, an error of signals or data sampled through the first receiver RX1 may increase.

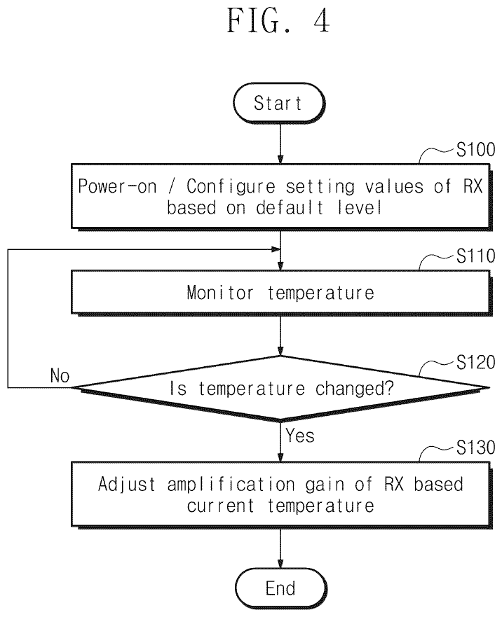

FIG. 4 is a flowchart illustrating an operation of a storage device of FIG. 1. Below, to describe embodiments of the present disclosure easily, an operation and components of the first receiver RX1 of the storage device 120 will be mainly described. However, example embodiments are not limited thereto.

Referring to FIGS. 1 to 4, in operation S100, the storage device 120 may be powered on and may perform the initialization operation, e.g., by executing instructions stored in firmware on the storage device 120. Through the initialization operation, the storage device 120 may configure the first receiver RX1 based on the default setting value. For example, in the initialization operation of the storage device 120, the link EQ and the link training of the first physical layer PHY1 may be performed. Through the link EQ and the link training, the storage device 120 may configure the first receiver RX1 based on the default setting value. For example, various components of the first receiver RX1 may be set or configured by using the default setting value. Afterwards and/or at least partly concurrently, the host 110 and the storage device 120 may perform a normal operation. For example, the host 110 and the storage device 120 may communicate with each other through the 0-th and first physical layers PHY0 and PHY1.

In operation S110, the storage device 120 may monitor a temperature. For example, the temperature sensor 121a included in the storage controller 121 of the storage device 120 may measure the temperature of the storage device 120.

In operation S120, the storage device 120 may determine whether the measured temperature changes. For example, the receiver control logic 121b included in the storage controller 121 of the storage device 120 may receive the temperature information TEMP from the temperature sensor 121a. The receiver control logic 121b may determine whether a current temperature of the storage device 120 changes, based on the temperature information TEMP. In some example embodiments, the receiver control logic 121b may determine whether the current temperature of the storage device 120 is higher than or equal to a reference temperature. Alternatively or additionally, the receiver control logic 121b may determine whether a temperature range in which the current temperature is included is changed.

When the temperature of the storage device 120 is not changed or is not significantly changed, the storage device 120 continues to perform operation S110.

When the temperature of the storage device 120 is changed or is significantly changed, in operation S130, the storage device 120 may adjust an amplification gain of the first receiver RX1, based on the current temperature. In some example embodiments, the storage device 120 may reconfigure the first receiver RX1 based on a setting value corresponding to the current temperature. For example, the first receiver RX1 may include the continuous time linear equalizer. The receiver control logic 121b may adjust an amplification gain of the continuous time linear equalizer of the first receiver RX1, based on the current temperature. As the amplification gain of the continuous time linear equalizer is adjusted, the height of the effective margin or data eye of the first receiver RX1 may increase.

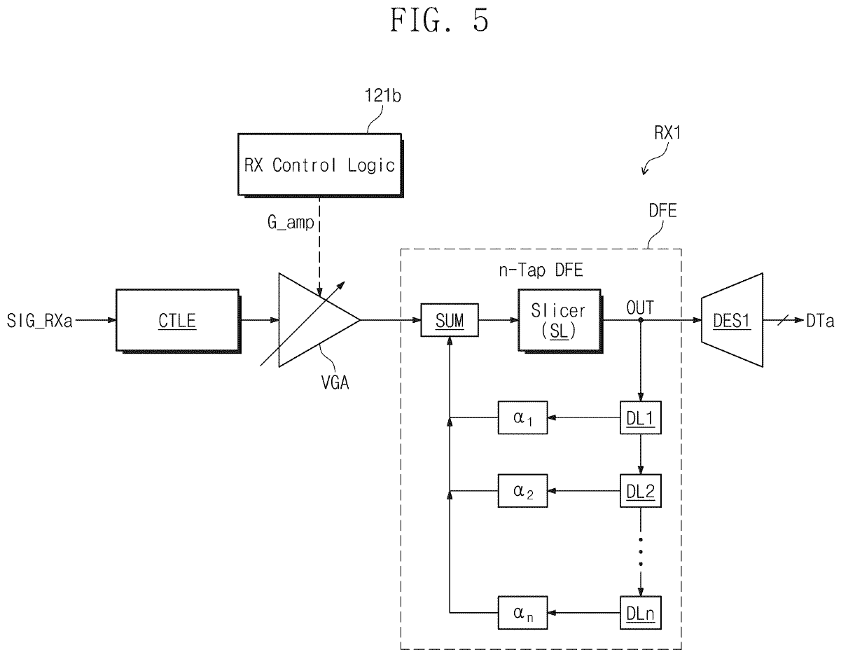

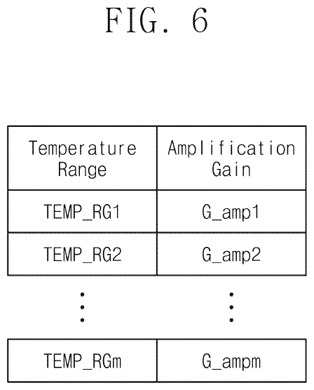

FIG. 5 is a block diagram illustrating a first receiver of FIG. 2 in detail. FIG. 6 is a diagram for describing an operation of a receiver control logic of FIG. 5. In some example embodiments, the first receiver RX1 of FIG. 5 is provided only as an example, and example embodiments are not limited thereto.

Referring to FIGS. 2, 5, and 6, the first receiver RX1 may include a continuous time linear equalizer CTLE, a variable gain amplifier VGA, and a decision feedback equalizer DFE.

The continuous time linear equalizer CTLE may receive the a-th receive signal SIG_RXa through the first signal line SIGL1. The continuous time linear equalizer CTLE may operate as a high-pass filter in association with the a-th receive signal SIG_RXa. The continuous time linear equalizer CTLE may be configured to pass or pass through a high-frequency component of the a-th receive signal SIG_RXa and to block a low-frequency noise caused by the first signal line SIGL1.

The variable gain amplifier VGA may be configured to amplify an output of the continuous time linear equalizer CTLE. In some example embodiments, the variable gain amplifier VGA may amplify the output of the continuous time linear equalizer CTLE, based on

### A Preset Amplification Gain.

The decision feedback equalizer DFE may sample an output of the variable gain amplifier VGA to output the a-th serialization data DTa_SER. For example, the decision feedback equalizer DFE may sum a level corresponding to a previous signal and a current signal to output data of the current signal.

The decision feedback equalizer DFE may include a summer SUM, a slicer SL, and a plurality of delay units DL1 to DLn. The slicer SL may sample the output of the variable gain amplifier VGA to output an output signal OUT. For example, the slicer SL may compare the output of the variable gain amplifier VGA with a reference voltage. When the output of the variable gain amplifier VGA is higher than or above the reference voltage, the slicer SL may output a signal of logic high as the output signal OUT; when the output of the variable gain amplifier VGA is lower than the reference voltage, the slicer SL may output a signal of logic low as the output signal OUT.

The plurality of delay units DL1 to DLn may be configured to sequentially delay the output signal OUT. For example, the plurality of delay units DL1 to DLn may be connected in a cascade form. The first delay unit DL1 may delay the output signal OUT as much as a preset time (e.g., one period of data). The second delay unit DL2 may delay an output of the first delay DL1 as much as the preset time. The n-th delay unit DLn may delay an output a delay unit before the n-th delay unit DLn as much as the preset time.

A plurality of weights α1 to αn may be applied to the outputs of the plurality of delay units DL1 to DLn. For example, the first weight α1 may be applied to the output of the first delay unit DL1. The second weight α2 may be applied to the output of the second delay unit DL2. The n-th weight αn may be applied to the output of the n-th delay unit DLn. Each of the plurality of weights α1 to αn may be real numbers; however, example embodiments are not limited thereto. Each of the plurality of weights α1 to αn may the same as each other, or at least one may be different from others. Each of the plurality of weights α1 to αn may positive; however, example embodiments are not limited thereto.

The signals to which the weights α1 to αn are applied may be summed by the summer SUM. The output of the summer SUM may be provided to the slicer SL. The slicer SL may compare an input signal with the reference voltage to output the output signal OUT.

As described above, the decision feedback equalizer DFE may generate the output signal OUT by applying information corresponding to a previous data value of the input signal to a current data value. In this case, the inter-symbol interference (ISI) of the input signal may be removed.

In some example embodiments, the decision feedback equalizer DFE may be or may include an n-tap decision feedback equalizer. However, example embodiments are not limited thereto. For example, the number of taps of the decision feedback equalizer DFE may be variously changed or modified, and thus, the number of delay units may be varied.

The output signal OUT of the decision feedback equalizer DFE may be provided to the first deserializer DES1 as the a-th serialization data DTa_SER. The first deserializer DES1 may deserialize the a-th serialization data DTa_SER to output the a-th data DTa.

In some example embodiments, an amplification gain G_amp of the variable gain amplifier VGA may be set to a setting value such as but not limited to a preset setting value and/or a good such as but not limited to an optimal value at a link EQ or link training time point through the link EQ and the link training of the storage device 120. In this case, when the temperature of the storage device 120 changes and/or when the temperature of the storage device 120 increases, the operation characteristic of the components of the first receiver RX1 may be changed. For example, the signal quality (e.g., the height of the data eye) of the signal output from the variable gain amplifier VGA may decrease.

In this case, the receiver control logic 121b may adjust the amplification gain G_amp of the variable gain amplifier VGA, based on the current temperature of the storage device 120. As an example, as illustrated in FIG. 6, when the current temperature of the storage device 120 is included in a first temperature range TEMP_RG1, the receiver control logic 121b may adjust the variable gain amplifier VGA to a first amplification gain G_amp1. Alternatively, when the current temperature of the storage device 120 is included in a second temperature range TEMP_RG2 that may or may not overlap with the first temperature range TEMP_RG1, the receiver control logic 121b may adjust the variable gain amplifier VGA to a second amplification gain G_amp2. Alternatively, when the current temperature of the storage device 120 is included in an m-th temperature range TEMP_RGm, the receiver control logic 121b may adjust the variable gain amplifier VGA to an m-th amplification gain G_ampm. In some example embodiments, the second temperature range TEMP_RG2 may be higher than the first temperature range TEMP_RG1, e.g., a low end of the second temperature range TEMP_RG2 may be greater than or equal to a high end of the first temperature range TEMP_RG1, and the second amplification gain G_amp2 may be greater than the first amplification gain G_amp1. For example, as the temperature of the storage device 120 increases, the receiver control logic 121b may increase the amplification gain G_amp of the variable gain amplifier VGA included in the first receiver RX1.

In some example embodiments, a good or an optimal amplification gain of the variable gain amplifier VGA may vary depending on the temperature of the storage device 120 or the temperature of the first receiver RX1. For example, at the room temperature, the first amplification gain G_amp1 may be the optimal amplification gain of the variable gain amplifier VGA. At a first temperature higher than the room temperature, the second amplification gain G_amp2 higher than the first amplification gain G_amp1 may be the optimal amplification gain of the variable gain amplifier VGA. At the room temperature, when the variable gain amplifier VGA is set to have the second amplification gain G_amp2, the output signal of the variable gain amplifier VGA may swing within a relatively wide range. In this case, when the output signal of the variable gain amplifier VGA transitions from the high level to the low level or from the low level to the high level, the output signal may fail to swing normally. In this case, even though the amplification gain increases, the eye height of data may become relatively lower.

For example, the good or optimal amplification gain of the variable gain amplifier VGA may vary depending on the temperature of the storage device 120, and the receiver control logic 121b may control the amplification gain of the variable gain amplifier VGA based on the temperature of the storage device 120.

In some example embodiments, the continuous time linear equalizer CTLE and the variable gain amplifier VGA of the first receiver RX1 may constitute an analog front end AFE of the first receiver RX1, and the decision feedback equalizer DFE of the first receiver RX1 may be a digital circuit of the first receiver RX1. The receiver control logic 121b may control the analog front end AFE of the first receiver RX1 depending on the temperature of the storage device 120.

In some example embodiments illustrated in FIGS. 5 and 6, the description is given as the receiver control logic 121b selects an amplification gain based on a temperature range in which the temperature of the storage device 120 is included, but example embodiments are not limited thereto. For example, the receiver control logic 121b may set the amplification gain G_amp to be linearly proportional to the temperature of the storage device 120.

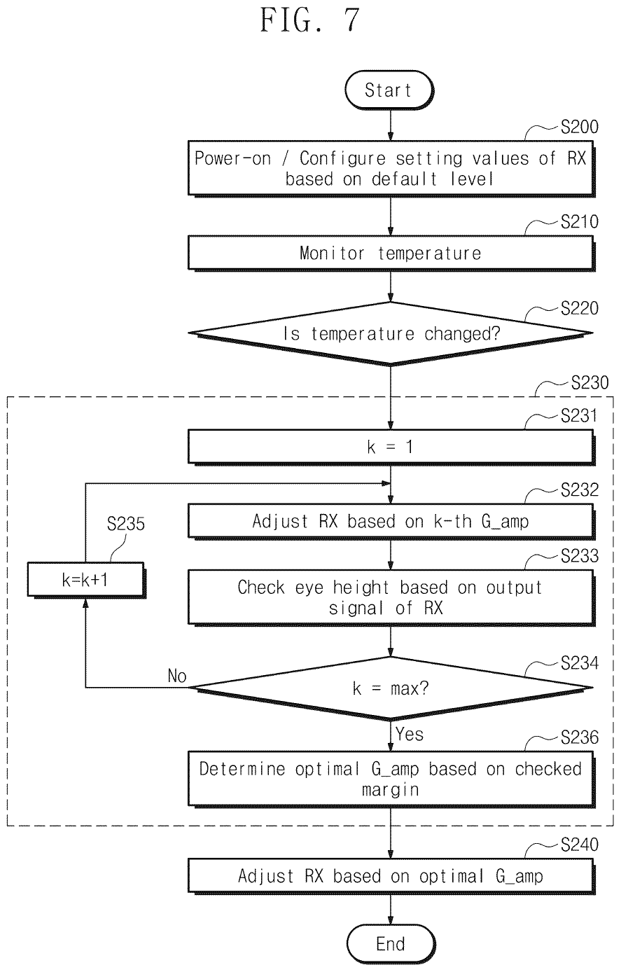

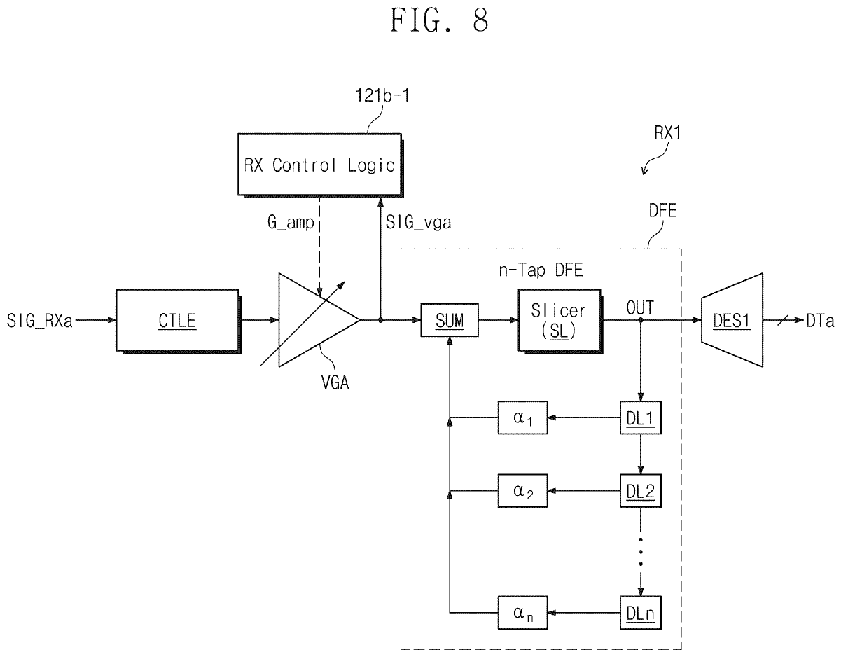

FIG. 7 is a flowchart illustrating an operation of a storage device of FIG. 1. FIG. 8 is a diagram for describing operation S230 of FIG. 7. For convenience of description, additional description associated with the components described above will be omitted to avoid redundancy. Referring to FIGS. 1, 2, 7, and 8, the storage device 120 may perform operation S200, operation S210, and operation S220. Operation S200, operation S210, and operation S220 are similar to operation S100, operation S110, and operation S120 of FIG. 4, and thus, additional description will be omitted to avoid redundancy.

When the temperature of the storage device 120 is changed, in operation S230, the storage device 120 may search for a good or an optimal amplification gain of the first receiver RX1. For example, operation S230 may include operation S231 to operation S236.

In operation S231, a variable “k” is set to 1. In some example embodiments, the variable “k” is for describing an iterative operation, e.g., as a dummy counter, for searching for a good or an optimal amplification gain of the storage device 120 and is not interpreted as any other technical meaning.

In operation S232, the storage device 120 may adjust the first receiver RX1 based on an k-th amplification gain. For example, as illustrated in FIG. 8, the first receiver RX1 may include the continuous time linear equalizer CTLE, the variable gain amplifier VGA, and the decision feedback equalizer DFE. The configurations and operations of the continuous time linear equalizer CTLE, the variable gain amplifier VGA, and the decision feedback equalizer DFE are described with reference to FIG. 5, and thus, additional description will be omitted to avoid redundancy. A receiver control logic 121b-1 may control the amplification gain G_amp of the variable gain amplifier VGA. In this case, the receiver control logic 121b-1 may adjust the variable gain amplifier VGA based on the k-th amplification gain.

In operation S233, the storage device 120 may check a signal margin based on the output signal of the first receiver RX1. For example, the receiver control logic 121b-1 may receive an output signal SIG_vga of the variable gain amplifier VGA set to the k-th amplification gain. The receiver control logic 121b-1 may check the signal margin of the output signal SIG_vga. In some example embodiments, the signal margin may indicate the eye height or magnitude of the output signal SIG_vga.

In operation S234, the storage device 120 may determine whether the variable “k” is maximal. For example, the receiver control logic 121b-1 may discriminate whether all configurable amplification gains are applied to the variable gain amplifier VGA.

When the variable “k” is not maximal, in operation S235, the variable “k” increases as much as “1”. Afterwards, the storage device 120 iteratively performs operation S231 to operation S234.

When the variable “k” is maximal (i.e., when all the amplification gains are applied), in operation S236, the storage device 120 may determine a good or an optimal amplification gain, based on the checked margins. For example, the receiver control logic 121b-1 may select an amplification gain corresponding to a good or an optimal margin among the checked margins as a good or optimal amplification gain.

In operation S240, the storage device 120 may adjust the first receiver RX1 based on the optimal amplification gain. For example, the receiver control logic 121b-1 may apply the good or optimal amplification gain to the variable gain amplifier VGA.

As described above, the receiver control logic 121b-1 may apply a plurality of amplification gains to the variable gain amplifier VGA and may check margins respectively corresponding to the amplification gains. The receiver control logic 121b-1 may select the optimal amplification gain corresponding to the optimal margin.

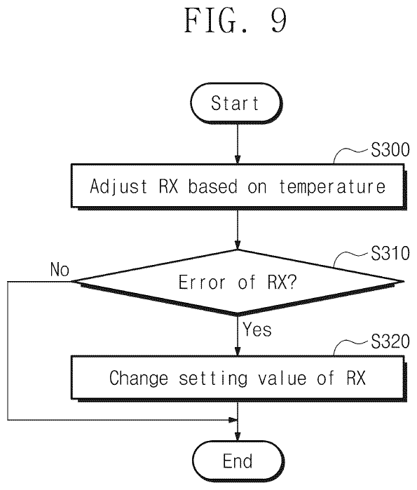

FIG. 9 is a flowchart illustrating an operation of a storage device of FIG. 1. Referring to FIGS. 1 and 9, in operation S300, the storage device 120 may adjust a setting value (e.g., an amplification gain) of the first receiver RX1 based on the temperature of the storage device 120. In some example embodiments, operation S300 may include the operation of adjusting the amplification gain of the first receiver RX1 depending on the temperature of the storage device 120, which is described with reference to FIGS. 1 to 8.

In operation S310, the storage device 120 may check an error of the first receiver RX1. For example, as illustrated in FIG. 8, the receiver control logic 121b-1 may adjust the amplification gain of the variable gain amplifier VGA and may check the output signal SIG_vga of the variable gain amplifier VGA. The receiver control logic 121b-1 may detect an error of the output signal SIG_vga (e.g., that the effective margin is not secured).

When the error of the first receiver RX1 is detected, in operation S320, the storage device 120 may change the setting value of the first receiver RX1. For example, when the error of the first receiver RX1 is detected, the receiver control logic 121b-1 may control setting values of various components included in the first receiver RX1. As an example, the receiver control logic 121b may adjust the setting value of the continuous time linear equalizer CTLE of the first receiver RX1. Alternatively or additionally, the receiver control logic 121b-1 may adjust the setting value of the decision feedback equalizer DFE.

As described above, after the amplification gain of the variable gain amplifier VGA is completely adjusted through operation S300, the effective margin of the first receiver RX1 may not be secured. In this case, the receiver control logic 121b-1 may recover the error of the first receiver RX1 by changing the setting value of the first receiver RX1.

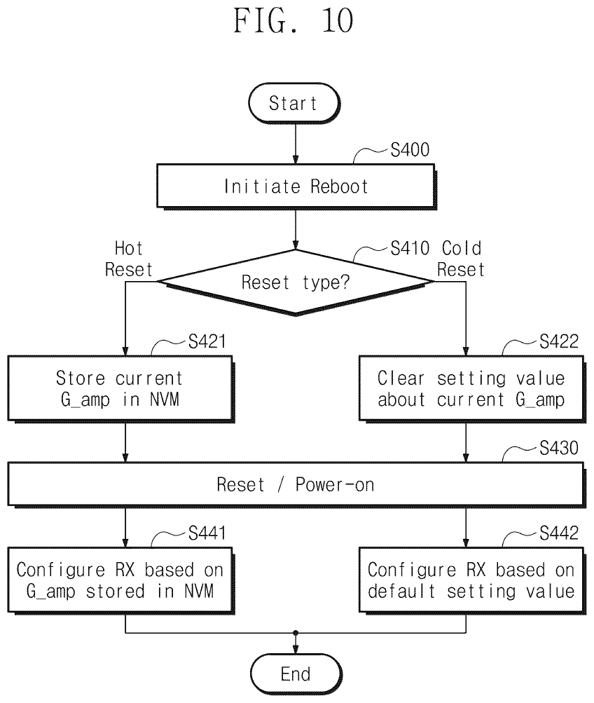

FIG. 10 is a flowchart illustrating an operation of a storage device of FIG. 1. Referring to FIGS. 1, 2, and 10, in operation S400, the storage device 120 may initiate a reset operation (or a reboot operation). For example, the storage device 120 may initiate the reset operation under control of the host 110.

In operation S410, the storage device 120 may determine a reset type. For example, the storage device 120 may perform a hot reset or a cold reset. The hot reset may indicate a reset operation which is performed in response to an explicit reset request received from the host 110 through the communication link. The cold reset may indicate a reset operation which is performed when the system 100 is powered on after the system 100 is powered off and/or when there is a sudden power-off event.

When the reset type corresponds to the hot reset, in operation S421, the storage device 120 may store information about a current amplification gain G_amp in the nonvolatile memory 122. When the reset type corresponds to the cold reset, in operation S422, the storage device 120 may clear the information about the current amplification gain G_amp.

In operation S430, the storage device 120 may perform the reset operation and then be powered-on.

In the case of the hot reset, in operation S441, the storage device 120 may configure the first receiver RX1 based on the amplification gain G_amp stored in the nonvolatile memory 122. In the case of the cold reset, in operation S442, the storage device 120 may configure the first receiver RX1 based on the default setting value.

In some example embodiments, in the case of the hot reset, because the storage device 120 performs the reset operation within a short time, the probability that the temperature of the storage device 120 is maintained is high. Accordingly, the reliability of the first receiver RX1 may be improved by setting the first receiver RX1 based on the preset amplification gain G_amp. In contrast, in the case of the cold reset, because a point in time when the reset operation is performed is not specified, the probability that the temperature of the storage device 120 decreases is high. Accordingly, the reliability of the first receiver RX1 may be improved by setting the first receiver RX1 based on the default setting value.

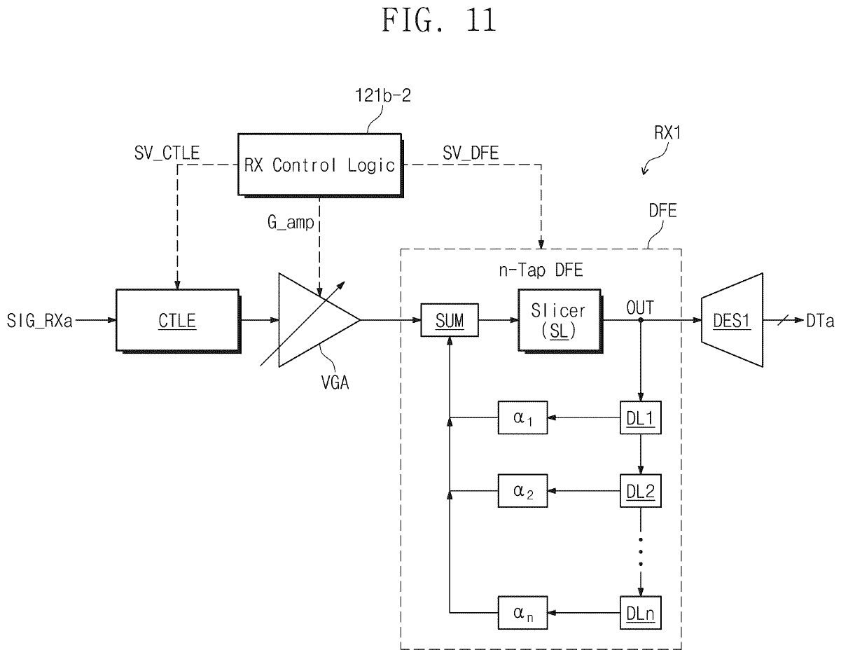

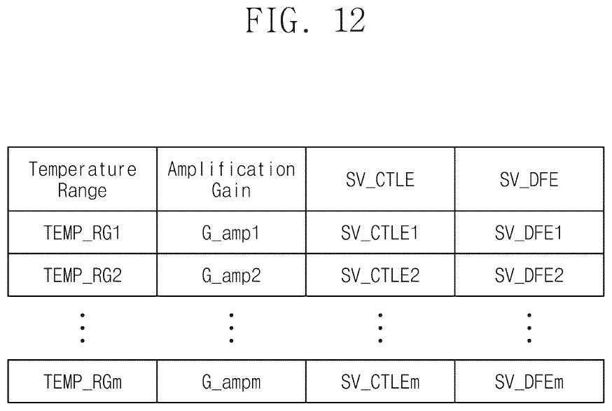

FIGS. 11 and 12 are diagrams for describing an operation of receiver control logic of FIG. 2. For convenience of description, additional description associated with the components described above will be omitted to avoid redundancy. Referring to FIGS., 2, 11, and 12, the first receiver RX1 may include the continuous time linear equalizer CTLE, the variable gain amplifier VGA, and the decision feedback equalizer DFE. The operations of the continuous time linear equalizer CTLE, the variable gain amplifier VGA, and the decision feedback equalizer DFE are described with reference to FIG. 5, and thus, additional description will be omitted to avoid redundancy.

In some example embodiments, each of the receiver control logic 121b and the receiver control logic 121b-1 controls the analog front end AFE of the first receiver RX1, for example, the amplification gain G_amp of the variable gain amplifier VGA depending on the temperature of the storage device 120. However, example embodiments are not limited thereto.

In some example embodiments, a receiver control logic 121b-2 of FIG. 11 may control the amplification gain G_amp of the variable gain amplifier VGA and may further control a setting value SV_CTLE (hereinafter, referred to as a “CTLE setting value”) of the continuous time linear equalizer CTLE and a setting value SV_DFE (hereinafter, referred to as a “DFE setting value”) of the decision feedback equalizer DFE.

In some example embodiments, as illustrated in FIG. 12, when the temperature of the storage device 120 is included in the first temperature range TEMP_RG1, the receiver control logic 121b may control the variable gain amplifier VGA based on the first amplification gain G_amp1, may control the continuous time linear equalizer CTLE based on the first CTLE setting value SV_CTLE1, and may control the decision feedback equalizer DFE based on the first DFE setting value SV_DFE1. When the temperature of the storage device 120 is included in the second temperature range TEMP_RG2, the receiver control logic 121b-2 may control the variable gain amplifier VGA based on the second amplification gain G_amp2, may control the continuous time linear equalizer CTLE based on the second CTLE setting value SV_CTLE2, and may control the decision feedback equalizer DFE based on the second DFE setting value SV_DFE2. When the temperature of the storage device 120 is included in the m-th temperature range temperature information TEMP_RGm, the receiver control logic 121b-2 may control the variable gain amplifier VGA based on the m-th amplification gain G_ampm, may control the continuous time linear equalizer CTLE based on the m-th CTLE setting value SV_CTLEm, and may control the decision feedback equalizer DFE based on the m-th DFE setting value SV_DFEm.

A size of each of the temperature ranges TEMP_RG1 to TEMP_RGm may be the same as each other; example embodiments are not limited thereto. A relation between the temperature ranges TEMP_RG1 to TEMP_RGm and each of the amplification gains G_amp1 to G_ampm, the setting value SV_CTLE1 to SV_CTLEm, and the setting value SV_DFE1 to SV_DFEm may be linear; however, example embodiments are not limited thereto, and a relationship may be nonlinear, such as polynomial and/or exponential and/or piecewise linear.

In some example embodiments, the plurality of amplification gains G_amp1 to G_ampm may be different from each other, or at least some of the plurality of amplification gains G_amp1 to G_ampm may be identical to each other. The plurality of CTLE setting values SV_CTLE1 to SV_CTLEm may be different from each other, or at least some of the plurality of CTLE setting values SV_CTLE1 to SV_CTLEm may be identical to each other. The plurality of DFE setting values SV_DFE1 to SV_DFEm may be different from each other, or at least some of the plurality of DFE setting values SV_DFE1 to SV_DFEm may be identical to each other. Alternatively or additionally, the relationship may be derived through iterative experimentation or test processes on various storage devices.

In some example embodiments, the continuous time linear equalizer CTLE may operate as a high-pass filter in association with the input signal. In this case, the CTLE setting value SV_CTLE may be a value corresponding to a DC gain or an AC gain of the continuous time linear equalizer CTLE. The operation characteristic or the output signal of the continuous time linear equalizer CTLE may be controlled by controlling the CTLE setting value SV_CTLE.

The decision feedback equalizer DFE may be configured to sum a signal corresponding to previous data and a current signal and to output data corresponding to the current signal. In this case, the DFE setting value SV_CTLE may indicate the number of coefficients to be applied to the signal corresponding to the previous data. For example, as the DFE setting value SV_DFE is controlled, an application ratio of the signal corresponding to the previous data may vary, and thus, the output signal of the decision feedback equalizer DFE may be controlled.

As described above, the receiver control logic 121b-2 may control an amplification gain and/or setting values of various components included in the first receiver RX1, based on the temperature of the storage device 120. According to the above description, even though the temperature of the storage device 120 increases, the effective margin of the first receiver RX1 may be secured or may be more likely to be secured.

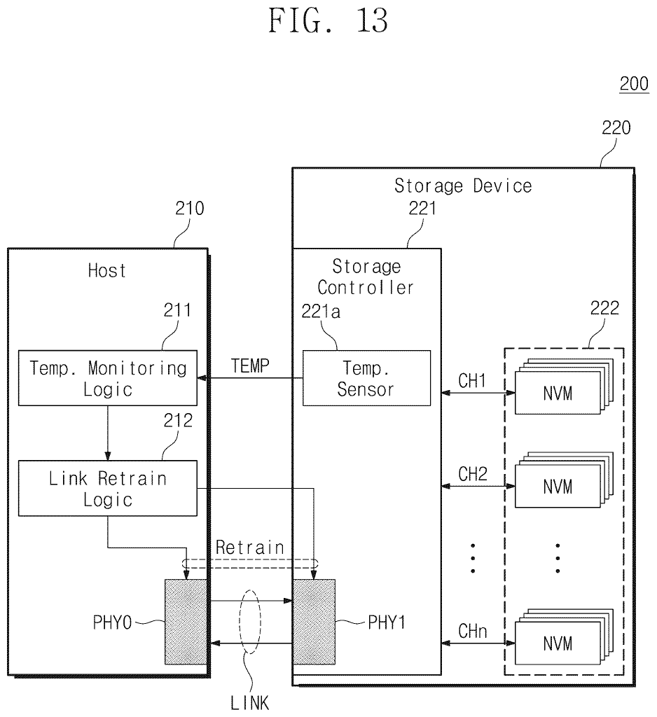

FIG. 13 is a block diagram illustrating a system according to some example embodiments. Referring to FIG. 13, a system 200 may include a host 210 and a storage device 220. The storage device 220 may include a storage controller 221 and a plurality of nonvolatile memories 222. The storage controller 221 may include a temperature sensor 221a. Operations of the host 210 and the storage device 220 are described with reference to FIG. 1, and thus, additional description will be omitted to avoid redundancy.

In some example embodiments, the host 210 may perform link retraining depending on the temperature of the storage device 220. For example, the host 210 may include temperature monitoring logic 211 and link retrain logic 212. The temperature monitoring logic 211 may receive the temperature information TEMP about the temperature of the storage device 220 from the temperature sensor 221a included in the storage device 220. As an example, the host 210 may receive the temperature information TEMP from the temperature sensor 221a periodically or randomly. As an example, the host 210 may check SMART information including the temperature information TEMP from the storage device 220 periodically or randomly.

The temperature monitoring logic 211 may determine whether the temperature of the storage device 220 changes, based on the temperature information TEMP. For example, the temperature monitoring logic 211 may determine whether the temperature of the storage device 220 is higher than the reference temperature, based on the temperature information TEMP. Alternatively or additionally, the temperature monitoring logic 211 may determine whether a temperature range in which the temperature of the storage device 220 is included is changed, based on the temperature information TEMP. When the temperature of the storage device 220 changes, the temperature monitoring logic 211 may provide a notification signal to the link retrain logic 212.

The link retrain logic 212 may perform the link retraining operation on the 0-th and first physical layers PHY0 and PHY1 in response to the notification signal. For example, the 0-th and first physical layers PHY0 and PHY1 may perform the link retraining operation defined by the PCIe standard under control of the link retrain logic 212. In this case, the effective margin of the first receiver RX1 included in the first physical layer PHY1 of the storage device 220 may be improved or optimized.

As described above, when the temperature of the storage device 220 changes, an effective margin of a receiver included in the first physical layer PHY1 of the storage device 220 may decrease. In this case, the host 210 may perform the link retraining operation based on the temperature of the storage device 220. According to the above description, the effective margin of the receiver included in the first physical layer PHY1 may be again secured.

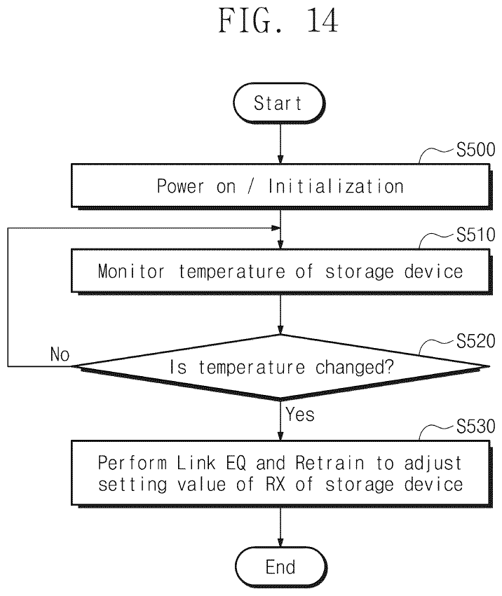

FIG. 14 is a flowchart illustrating an operation of a host of FIG. 13. Referring to FIGS. 13 and 14, in operation S500, the host 210 may be powered on and may perform the initialization operation. For example, the host 210 may perform the initialization operation with the storage device 220.

In operation S510, the host 210 may monitor the temperature of the storage device 220. For example, the storage device 220 may include the temperature sensor 221a. The host 210 may receive the temperature information TEMP about the temperature of the storage device 220 from the temperature sensor 221a of the storage device 220 periodically or randomly. In some example embodiments, the host 210 may receive the SMART information including the temperature information TEMP from the storage device 220 periodically or randomly.

In operation S520, the host 210 may determine whether the temperature of the storage device 220 changes. For example, the temperature monitoring logic 211 of the host 210 may determine whether the temperature of the storage device 220 changes, based on the temperature information TEMP. Alternatively or additionally, the temperature monitoring logic 211 of the host 210 may determine whether the temperature of the storage device 220 exceeds the reference temperature, based on the temperature information TEMP. Alternatively, the temperature monitoring logic 211 of the host 210 may determine whether a temperature range in which the temperature of the storage device 220 is included changes, based on the temperature information TEMP.

When the temperature of the storage device 220 changes, in operation S530, the host 210 may perform link retraining to adjust the setting value of the first receiver RX1 of the storage device 220. For example, the link retrain logic 212 of the host 210 may perform link retraining on the 0-th and first physical layers PHY0 and PHY1. In this case, setting values of transmitters and receivers included in the 0-th and first physical layers PHY0 and PHY1 may be improved or optimized. For example, the effective margin of the transmitters and the receivers included in the 0-th and first physical layers PHY0 and PHY1 may be secured.

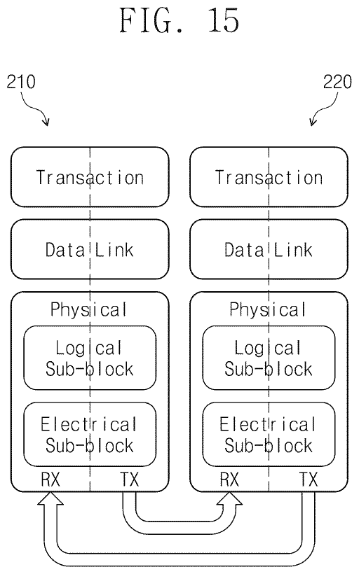

FIG. 15 is a diagram illustrating a hierarchical structure of a host and a storage device of FIG. 13. Referring to FIGS. 13 and 15, the host 210 may include a transaction layer, a data link layer, and a physical layer. The transaction layer may be configured to assemble and disassemble a transaction layer packet TLP. The transaction layer packet may be used to communicate an event of a read, write, or specific type. The transaction layer may be configured to control the flow of the transaction layer packet TLP.

The data link layer may be an intermediate layer between the transaction layer and the physical layer. The data link layer may be configured to perform data integrity and link management including error detection and error correction.

The physical layer may include circuits for an interface operation. The physical layer may include a logical sub-block and an electrical sub-block. The logical sub-block may be configured to perform a function associated with interface initialization and management. The electrical sub-block may include circuit components (e.g., a transmitter TX and a receiver RX) configured to transmit a signal to the storage device 220 or to receive a signal from the storage device 220.

The storage device 220 may include a transaction layer, a data link layer, and a physical layer. Functions and configurations of the transaction layer, the data link layer, and the physical layer of the storage device 220 are similar to those of the host 210, and thus, additional description will be omitted to avoid redundancy.

In some example embodiments, the logical sub-block of the physical layer of each of the host 210 and the storage device 220 may include a link training and state machine (LTSSM). The LTSSM may be configured to control link retraining. In some example embodiments, the link retrain logic 212 may be the LTSSM included in the logical sub-block of the physical layer. Alternatively or additionally, the link retrain logic 212 may be or may include, or be included in, a function block and/or hardware configured to control the LTSSM included in the logical sub-block of the physical layer.

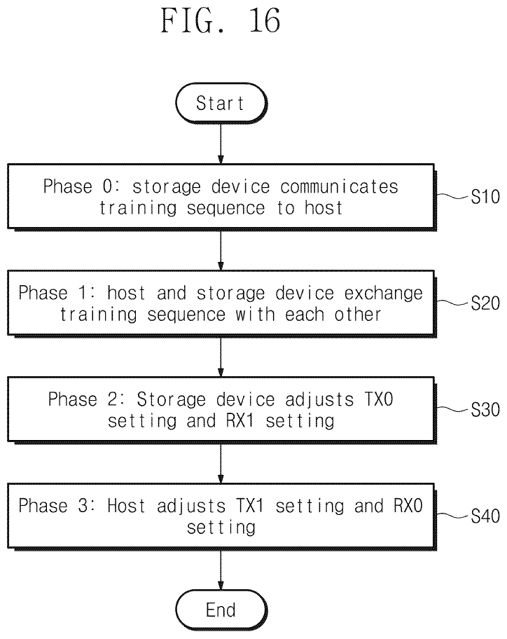

FIG. 16 is a flowchart illustrating a link retraining operation of a host device and a storage device of FIG. 13. Referring to FIGS. 13, 15, and 16, the host 210 and the storage device 220 may perform link retraining through operation S10 to operation S30. In some example embodiments, operation S10 to operation S30 may correspond to the link EQ procedure included in the link retraining.

Below, for convenience of description, as in the above description given with reference to FIG. 2, it is assumed that the 0-th physical layer PHY0 of the host 210 includes the 0-th transmitter TX0 and the 0-th receiver RX0 and the first physical layer PHY1 of the storage device 220 includes the first transmitter TX1 and the first receiver RX1.

In operation S10, the host 210 and the storage device 220 may perform an operation of phase 0. As an example, in the operation of phase 0, the storage device 220 may communicate a training sequence to the host 210. For example, the storage device 220 may transmit transmitter preset values and transmitter preset hints by using 8b/10b encoding to the host device 210. In some example embodiments, the transmitter preset values and the transmitter preset hints may be transmitted by using an EQ TS2 (Training sequence 2) ordered set.

In operation S20, the host 210 and the storage device 220 may perform an operation of phase 1. As an example, in the operation of phase 1, the host 210 and the storage device 220 may exchange the training sequence with each other. For example, the host 210 and the storage device 220 may exchange a TS1 ordered set for completing fine tuning of a transmitter and transmitters in next operations.

In operation S30, the host 210 and the storage device 220 may perform an operation of phase 2. As an example, in the operation of phase 2, the storage device 220 may adjust the setting value of the 0-th transmitter TX0 of the host 210 and the setting value of the first receiver RX1 of the storage device 220. For example, the storage device 220 requests a preset or a coefficient of the 0-th transmitter TX0 of the host 210. The host 210 transmits, to the storage device 220, a signal corresponding to the preset or coefficient requested from the storage device 220. The storage device 220 receives the signal from the host 210 and request another preset and another coefficient to the host 210. As the above operation is iteratively performed, the 0-th transmitter TX0 of the host 210 and the first receiver RX1 of the storage device 220 may be improved or optimized.

In operation S40, the host 210 and the storage device 220 may perform an operation of phase 3. As an example, in the operation of phase 3, the host 210 may adjust the setting value of the first transmitter TX1 of the storage device 220 and the setting value of the 0-th receiver RX0 of the host 210. In some example embodiments, a way to perform the operation of phase 3 is similar to the way to perform the operation of phase 2 except that the subjects in phase 2 and phase 3 are switched, and thus, additional description will be omitted to avoid redundancy.

In some example embodiments, the host 210 may be a downstream port, and the storage device 220 may be an upstream port. In this case, a downstream lane between the host 210 and the storage device 220 may be improved or optimized through the operation of phase 2, and an upstream lane between the host 210 and the storage device 220 may be improved or optimized through the operation of phase 3.

According to some example embodiments, the host 210 may sense a temperature change of the storage device 220 and may perform link retraining depending on the temperature change of the storage device 220. In this case, even though the temperature of the storage device 220 increases, the first receiver RX1 of the storage device 220 may secure or be more likely to secure the effective margin through the link retraining.

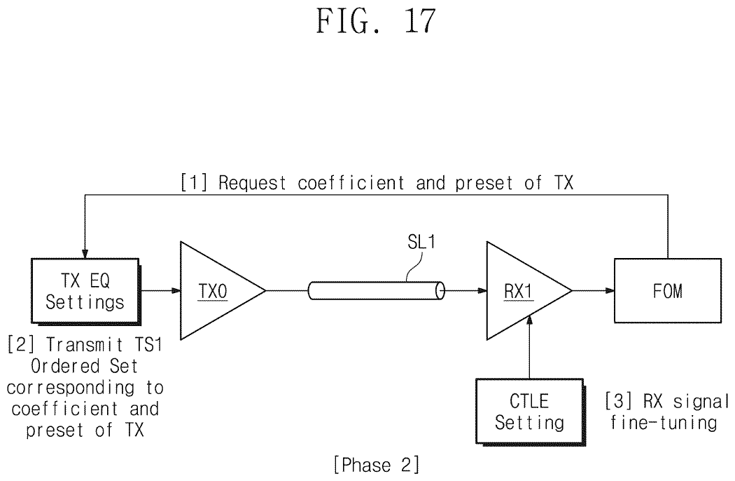

FIG. 17 is a diagram for describing an operation of phase 2 of FIG. 16. For convenience of description, components which are unnecessary to describe the operation of phase 2 are omitted. Referring to FIGS. 13 and 17, the host 210 and the storage device 220 may optimize the 0-th transmitter TX0 and the first receiver RX1. For example, the storage device 220 may request the preset value or a coefficient of the 0-th transmitter TX0 from the host 210 (operation [1]). In response to the request, the host 210 may transmit a signal corresponding to the value such as the preset value or the coefficient to the storage device 220 through the first signal line SIGL1 (operation [2]). For example, the 0-th transmitter TX0 of the host 210 may be an equalization transmitter including a feed forward equalizer (FFE). The host 210 may control EQ settings of the 0-th transmitter TX0 based on the preset value or the coefficient.

The storage device 220 may receive the signal from the 0-th transmitter TX0 through the first signal line SIGL1 and the first receiver RX1 and may perform evaluation (e.g., figure of merit (FOM)). The storage device 220 may control the setting value of the continuous time linear equalizer CTLE of the first receiver RX1, based on an evaluation result. Afterwards, the storage device 220 may request other values such as other preset values and other coefficients of the 0-th transmitter TX0 from the host 210 (e.g., iteration of operation [1]). As the above operations are iterated, the 0-th transmitter TX0 and the first receiver RX1 may be improved or optimized.

In some example embodiments, as the temperature of the storage device 220 increases, the host 210 may perform link retraining. In this case, the host 210 and the storage device 220 may perform the link retraining operations (e.g., the operations of phase 0 to phase 3) described with reference to FIG. 16. However, example embodiments are not limited thereto. For example, when the temperature of the storage device 220 increases, the host 210 may perform only the operation of phase 2 to secure the effective margin of the first receiver RX1 of the storage device 220. For example, when the temperature of the storage device 220 increases, under control of the host 210 or depending on a request of the host 210, the host 210 and the storage device 220 may optimize the downstream lane.

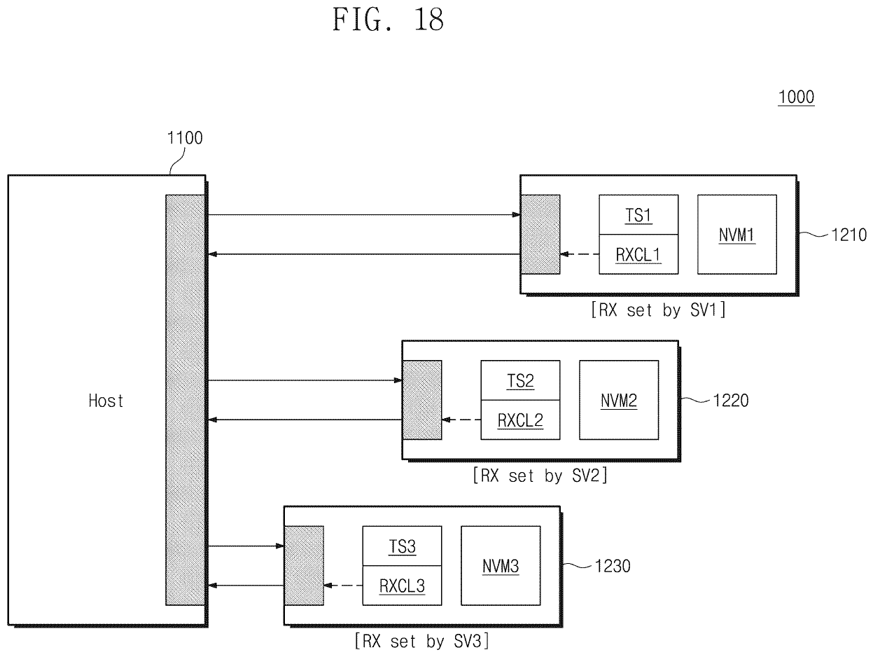

FIG. 18 is a block diagram illustrating a system according to some example embodiments. Referring to FIG. 18, a system 1000 may include a host 1100 and a plurality of storage devices 1210 to 1230. Three storage devices 1210 to 1230 are illustrated in FIG. 18, but example embodiments are not limited thereto. For example, the host 1100 may communicate with more storage devices.

The host 1100 may individually control the plurality of storage devices 1210 to 1230. Temperatures of the plurality of storage devices 1210 to 1230 may be different from each other, for example, depending on an operation environment. For example, the host 1100 and the plurality of storage devices 1210 to 1230 may be mounted in a single server rack. In this case, temperatures of the plurality of storage devices 1210 to 1230 may be different depending on locations of the plurality of storage devices 1210 to 1230. Alternatively or additionally, temperatures of the plurality of storage devices 1210 to 1230 may be different depending on workloads.

The first storage device 1210 may have a first temperature, the second storage device 1220 may have a second temperature higher than the first temperature, and the third storage device 1230 may have a third temperature higher than the second temperature. In this case, as described above, receivers RX of the plurality of storage devices 1210 to 1230 may be set to different setting values. For example, the first storage device 1210 may include a first temperature sensor TS1, a first receiver control logic RXCL1, and a first nonvolatile memory NVM1. The first temperature sensor TS1 may monitor a temperature of the first storage device 1210. The first receiver control logic RXCL1 may adjust a receiver included in the first storage device 1210 based on a first setting value SV1 corresponding to the temperature of the first storage device 1210. The second storage device 1220 may include a second temperature sensor TS2, a second receiver control logic RXCL2, and a second nonvolatile memory NVM2. The second temperature sensor TS2 may monitor a temperature of the second storage device 1220. The second receiver control logic RXCL2 may adjust a receiver included in the second storage device 1220 based on a second setting value SV2 corresponding to the temperature of the second storage device 1220. The third storage device 1230 may include a third temperature sensor TS3, a third receiver control logic RXCL3, and a third nonvolatile memory NVM3. The third temperature sensor TS3 may monitor a temperature of the third storage device 1230. The third receiver control logic RXCL3 may adjust a receiver included in the third storage device 1230 based on a third setting value SV3 corresponding to the temperature of the third storage device 1230.

In some example embodiments, each of the first to third receiver control logics RXCL1 to RXCL3 may be or may include the receiver control logic 121b, 121b-1, or 121b-2 described with reference to FIGS. 1 to 12 and/or may operate based on the method described with reference to FIGS. 1 to 12.

As described above, the host 1100 may communicate with the plurality of storage devices 1210 to 1230. In this case, operation temperatures of the plurality of storage devices 1210 to 1230 may be different from each other. In this case, each of the plurality of storage devices 1210 to 1230 may set the receiver included therein, based on a setting value corresponding to the operation temperature. Accordingly, even though the operation temperatures of the plurality of storage devices 1210 to 1230 are different from each other, the receivers may be individually controlled, and thus, the effective margin of each of the receivers may be secured.

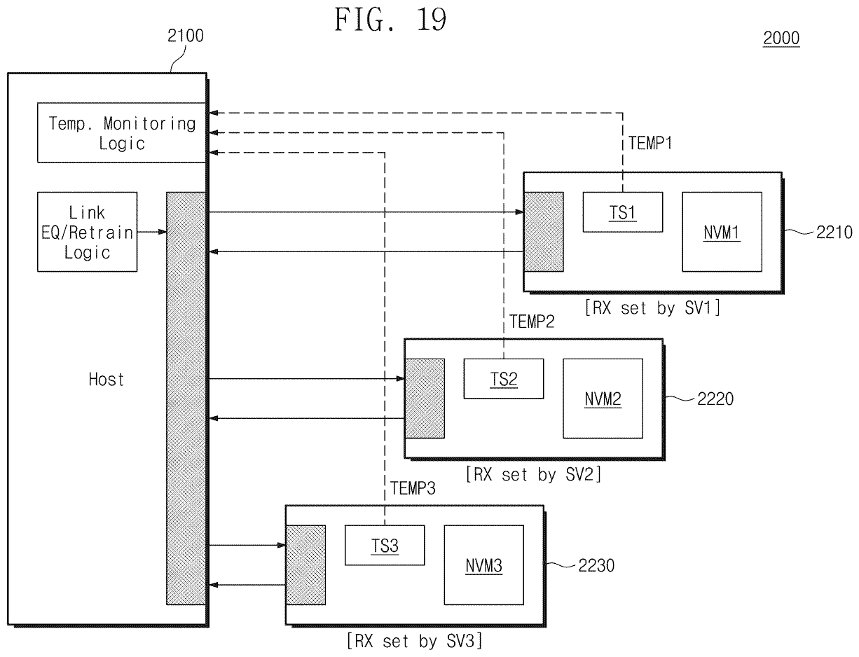

FIG. 19 is a block diagram illustrating a system according to some example embodiments. Referring to FIG. 19, a system 2000 may include a host 2100 and a plurality of storage devices 2210 to 2230. The host 2100 may communicate with the plurality of storage devices 2210 to 2230. As described with reference to FIG. 18, the plurality of storage devices 2210 to 2230 may have different temperatures.

The plurality of storage devices 2210 to 2230 may include temperature sensors TS1 to TS3, respectively. The host 2100 may collect temperature information TEMP1 to TEMP3 of the plurality of storage devices 2210 to 2230 from the temperature sensors TS1 to TS3 of the plurality of storage devices 2210 to 2230, respectively. For example, temperature monitoring logic of the host 2100 may collect the temperature information TEMP1 to TEMP3

### Of the Plurality of Storage Devices 2210 to 2230.

Link EQ/retrain logic of the host 2100 may perform link retraining for each of the plurality of storage devices 2210 to 2230, based on the temperature information TEMP1 to TEMP3. For example, the host 2100 may determine that the temperature of the first storage device 2210 changes or exceeds the reference temperature, based on the first temperature information TEMP1. In this case, the host 2100 may perform link retraining on the physical layer of the first storage device 2210, based on the operation method described with reference to FIGS. 13 to 17. Accordingly, even though the temperature of the first storage device 2210 changes or increases, the effective margin of the receiver included in the physical layer of the first storage device 2210 may be secured. In some example embodiments, the host 2100 may perform link retraining for each of the plurality of storage devices 2210 to 2230. Accordingly, the optimization of the receivers respectively included in the plurality of storage devices 2210 to 2230 may be maintained depending on temperatures of the plurality of storage devices 2210 to 2230.

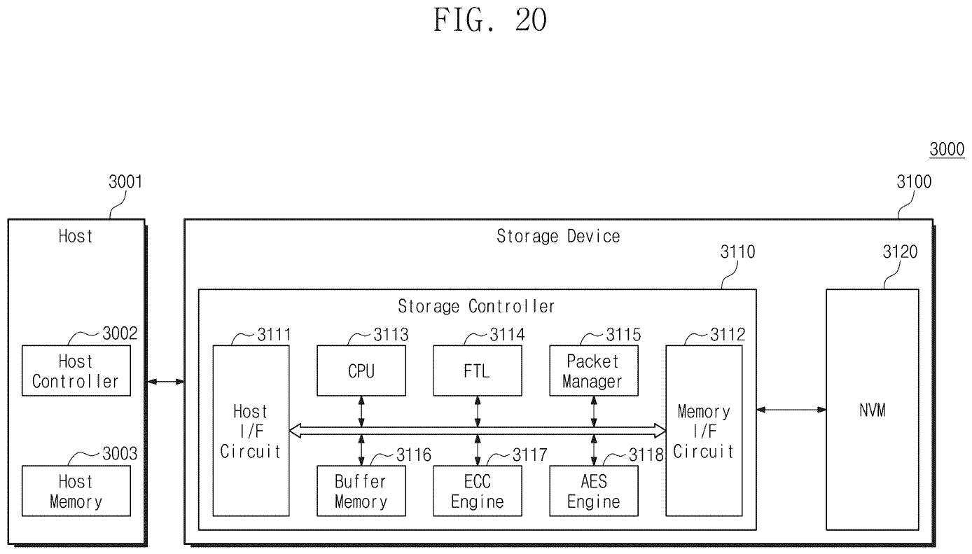

FIG. 20 is a block diagram of a host storage system 3000 according to an example embodiment.

The host storage system 3000 may include a host 3001 and a storage device 3100. Further, the storage device 3100 may include a storage controller 3110 and an NVM 3120. According to some example embodiments, the host 3001 may include a host controller 3002 and a host memory 3003. The host memory 3003 may serve as a buffer memory configured to temporarily store data to be transmitted to the storage device 3100 or data received from the storage device 3100.

The storage device 3100 may include storage media configured to store data in response to requests from the host 3001. As an example, the storage device 3100 may include at least one of an SSD, an embedded memory, and a removable external memory. When the storage device 3100 is or includes an SSD, the storage device 3100 may be, may include, or may be included in a device that conforms to an NVMe standard. When the storage device 3100 is or includes an embedded memory or an external memory, the storage device 3100 may be, may include, or may be included in a device that conforms to a UFS standard or an eMMC standard. Each of the host 3001 and the storage device 3100 may generate a packet according to an adopted standard protocol and transmit the packet.

When the NVM 3120 of the storage device 3100 includes a flash memory, the flash memory may include a 31D NAND memory array or a 3D (or vertical) NAND (VNAND) memory array. Alternatively or additionally, the storage device 3100 may include various other kinds of NVMs. For example, the storage device 3100 may include magnetic RAM (MRAM), spin-transfer torque MRAM, conductive bridging RAM (CBRAM), ferroelectric RAM (FRAM), PRAM, RRAM, and various other kinds of memories.

According to some example embodiments, the host controller 3002 and the host memory 3003 may be implemented as separate semiconductor chips. Alternatively, in some example embodiments, the host controller 3002 and the host memory 3003 may be integrated in the same semiconductor chip. As an example, the host controller 3002 may be any one of a plurality of modules included in an application processor (AP). The AP may be implemented as a System on Chip (SoC). Further, the host memory 3003 may be an embedded memory included in the AP or an NVM or memory module located outside the AP.

The host controller 3002 may manage an operation of storing data (e.g., write data) of a buffer region of the host memory 3003 in the NVM 3120 or an operation of storing data (e.g., read data) of the NVM 3120 in the buffer region.

The storage controller 3110 may include a host interface 3111, a memory interface 3112, and a CPU 3113. Further, the storage controllers 3110 may further include a flash translation layer (FTL) 3114, a packet manager 3115, a buffer memory 3116, an error correction code (ECC) engine 3117, and an advanced encryption standard (AES) engine 3118. The storage controllers 3110 may further include a working memory (not shown) in which the FTL 3114 is loaded. The CPU 3113 may execute the FTL 3114 to control data write and read operations on the NVM 3120.

The host interface 3111 may transmit and receive packets to and from the host 3001. A packet transmitted from the host 3001 to the host interface 3111 may include a command or data to be written to the NVM 3120. A packet transmitted from the host interface 3111 to the host 3001 may include a response to the command and/or data read from the NVM 3120. The memory interface 3112 may transmit data to be written to the NVM 3120 to the NVM 3120 or receive data read from the NVM 3120. The memory interface 3112 may be configured to comply with a standard protocol, such as Toggle or open NAND flash interface (ONFI).

The FTL 3114 may perform various functions, such as one or more of an address mapping operation, a wear-leveling operation, and a garbage collection operation. The address mapping operation may be an operation of converting a logical address received from the host 3001 into a physical address used to actually store data in the NVM 3120. The wear-leveling operation may be a technique for preventing excessive deterioration of a specific block by allowing blocks of the NVM 3120 to be uniformly used. As an example, the wear-leveling operation may be implemented using a firmware technique that balances erase counts of physical blocks. The garbage collection operation may be a technique for ensuring usable capacity in the NVM 3120 by erasing an existing block after copying valid data of the existing block to a new block.

The packet manager 3115 may generate a packet according to a protocol of an interface, which consents to the host 3001, or parse various types of information from the packet received from the host 3001. In addition, the buffer memory 3116 may temporarily store data to be written to the NVM 3120 or data to be read from the NVM 3120. Although the buffer memory 3116 may be a component included in the storage controllers 3110, the buffer memory 3116 may be outside the storage controllers 3110.

The ECC engine 3117 may perform error detection and correction operations on read data read from the NVM 3120. More specifically, the ECC engine 3117 may generate parity bits for write data to be written to the NVM 3120, and the generated parity bits may be stored in the NVM 3120 together with write data. During the reading of data from the NVM 3120, the ECC engine 3117 may correct an error in the read data by using the parity bits read from the NVM 3120 along with the read data, and output error-corrected read data.

The AES engine 3118 may perform at least one of an encryption operation and a decryption operation on data input to the storage controllers 3110 by using a symmetric-key algorithm.

In some example embodiments, the host 3001 of FIG. 20 may be one of the hosts 110, 210, 1100, and 2100 of FIGS. 1 to 19, and the storage device 3100 of FIG. 20 may be one of the storage devices 120, 220, 1210 to 1230, and 2210 to 2230. For example, the host 3001 may perform link retraining between the host 3001 and the storage device 3100 in response to an operation temperature of the storage device 3100 or a change in the operation temperature. Alternatively or additionally, the storage device 3100 may adjust a setting value of a receiver included in the host interface circuit 3111 in response to an operation temperature of the storage device 3100 or a change in the operation temperature.

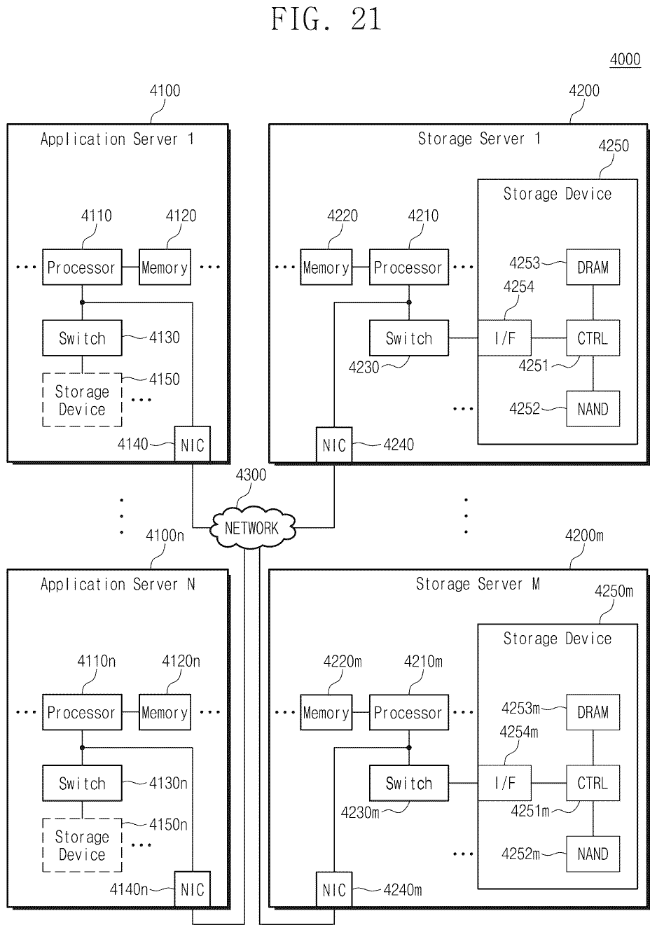

FIG. 21 is a diagram of a data center 4000 to which a memory device is applied, according to some example embodiments.

Referring to FIG. 21, the data center 4000 may be a facility that collects various types of pieces of data and provides services and be referred to as a data storage center. The data center 4000 may be a system for operating a search engine and a database, and may be a computing system used by companies, such as banks, or government agencies. The data center 4000 may include application servers 4100 to 4100n and storage servers 4200 to 4200m. The number of application servers 4100 to 4100n and the number of storage servers 4200 to 4200m may be variously selected according to embodiments. The number of application servers 4100 to 4100n may be different from the number of storage servers 4200 to 4200m.

The application server 4100 or the storage server 4200 may include at least one of processors 4110 and 4210 and memories 4120 and 4220. The storage server 4200 will now be described as an example. The processor 4210 may control all operations of the storage server 4200, access the memory 4220, and execute instructions and/or data loaded in the memory 4220. The memory 4220 may be, may include, or may be included in one or more of a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 4210 and memories 4220 included in the storage server 4200 may be variously selected. In some example embodiments, the processor 4210 and the memory 4220 may provide a processor-memory pair. In some example embodiments, the number of processors 4210 may be different from the number of memories 4220. The processor 4210 may include a single-core processor or a multi-core processor. The above description of the storage server 4200 may be similarly applied to the application server 4100. In some example embodiments, the application server 4100 may not include a storage device 4150. The storage server 4200 may include at least one storage device 4250. The number of storage devices 4250 included in the storage server 4200 may be variously selected according to embodiments.

The application servers 4100 to 4100n may communicate with the storage servers 4200 to 4200m through a network 4300. The network 4300 may be implemented by using a fiber channel (FC) and/or Ethernet. In this case, the FC may be a medium used for relatively high-speed data transmission and use an optical switch with high performance and high availability. The storage servers 4200 to 4200m may be provided as one or more of file storages, block storages, or object storages according to an access method of the network 4300.

In some example embodiments, the network 4300 may be, may include, or may be included in a storage-dedicated network, such as a storage area network (SAN). For example, the SAN may be an FC-SAN, which uses an FC network and is implemented according to an FC protocol (FCP). As another example, the SAN may be, may include, or may be included in an Internet protocol (IP)-SAN, which uses a transmission control protocol (TCP)/IP network and is implemented according to a SCSI over TCP/IP or Internet SCSI (iSCSI) protocol. In some example embodiments, the network 4300 may be, may include, or may be included in a general network, such as a TCP/IP network. For example, the network 4300 may be implemented according to a protocol, such as FC over Ethernet (FCoE), network attached storage (NAS), and NVMe over Fabrics (NVMe-oF).

Hereinafter, the application server 4100 and the storage server 4200 will mainly be described. A description of the application server 4100 may be applied to another application server 4100n, and a description of the storage server 4200 may be applied to another storage server 4200m.

The application server 4100 may store data, which is requested by a user or a client to be stored, in one of the storage servers 4200 to 4200m through the network 4300. Also, the application server 4100 may obtain data, which is requested by the user or the client to be read, from one of the storage servers 4200 to 4200m through the network 4300. For example, the application server 4100 may be implemented as a web server and/or a database management system (DBMS).

The application server 4100 may access a memory 4120n or a storage device 4150n, which is included in another application server 4100n, through the network 4300. Alternatively or additionally, the application server 4100 may access memories 4220 to 4220m or storage devices 4250 to 4250m, which are included in the storage servers 4200 to 4200m, through the network 4300. Thus, the application server 4100 may perform various operations on data stored in application servers 4100 to 4100n and/or the storage servers 4200 to 4200m. For example, the application server 4100 may execute an instruction for moving or copying data between the application servers 4100 to 4100n and/or the storage servers 4200 to 4200m. In this case, the data may be moved from the storage devices 4250 to 4250m of the storage servers 4200 to 4200m to the memories 4120 to 4120n of the application servers 4100 to 4100n directly or through the memories 4220 to 4220m of the storage servers 4200 to 4200m. The data moved through the network 4300 may be data encrypted for security or privacy.

The storage server 4200 will now be described as an example. An interface 4254 may provide physical connection between a processor 4210 and a controller 4251 and a physical connection between a network interface card (NIC) 4240 and the controller 4251. For example, the interface 4254 may be implemented using a direct attached storage (DAS) scheme in which the storage device 4250 is directly connected with a dedicated cable. For example, the interface 4254 may be implemented by using various interface schemes, such as one or more of ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 4200 may further include a switch 4230 and the NIC (Network InterConnect) 4240. The switch 4230 may selectively connect the processor 4210 to the storage device 4250 or selectively connect the NIC 4240 to the storage device 4250 via the control of the processor 4210.

In some example embodiments, the NIC 4240 may include a network interface card and a network adaptor. The NIC 4240 may be connected to the network 4300 by a wired interface, a wireless interface, a Bluetooth interface, or an optical interface. The NIC 4240 may include an internal memory, a digital signal processor (DSP), and a host bus interface and be connected to the processor 4210 and/or the switch 4230 through the host bus interface. The host bus interface may be implemented as one of the above-described examples of the interface 4254. In some example embodiments, the NIC 4240 may be integrated with at least one of the processor 4210, the switch 4230, and the storage device 4250.

In the storage servers 4200 to 4200m or the application servers 4100 to 4100n, a processor may transmit a command to storage devices 4150 to 4150n and 4250 to 4250m or the memories 4120 to 4120n and 4220 to 4220m and program or read data. In this case, the data may be data of which an error is corrected by an ECC engine. The data may be data on which a data bus inversion (DBI) operation and/or a data masking (DM) operation is performed, and may include cyclic redundancy code (CRC) information. The data may be data encrypted for security and/or for privacy.

Storage devices 4150 to 4150n and 4250 to 4250m may transmit a control signal and a command/address signal to NAND flash memory devices 4252 to 4252m in response to a read command received from the processor. Thus, when data is read from the NAND flash memory devices 4252 to 4252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 4251 may control all operations of the storage device 4250. In some example embodiments, the controller 4251 may include SRAM. The controller 4251 may write data to the NAND flash memory device 4252 in response to a write command or read data from the NAND flash memory device 4252 in response to a read command. For example, the write command and/or the read command may be provided from the processor 4210 of the storage server 4200, the processor 4210m of another storage server 4200 m, or the processors 4110 and 4110n of the application servers 4100 and 4100n. DRAM 4253 may temporarily store (or buffer) data to be written to the NAND flash memory device 4252 or data read from the NAND flash memory device 4252. Also, the DRAM 4253 may store metadata. Here, the metadata may be user data or data generated by the controller 4251 to manage the NAND flash memory device 4252. The storage device 4250 may include a secure element (SE) for security or privacy.

In some example embodiments, the storage devices 4150 to 4150n and 4250 to 4250m of FIG. 21 may be the storage device described with reference to one or more of FIGS. 1 to 20 or may operate based on the operation method described with reference to FIGS. 1 to 20. In some example embodiments, each of the application servers 4110 to 4110n of FIG. 21, the storage servers 4200 to 4200 m, or the processors 4110 to 4110 n and 4210 to 4210m included therein may be or may correspond to the host described with reference to one or more of FIGS. 1 to 20 or may operate based on the operation method described with reference to FIGS. 1 to 20. Accordingly, the effective margin of a receiver included in each of the storage devices 4150 to 4150n and 4250 to 4250m may be secured depending on temperatures of the storage devices 4150 to 4150n and 4250 to 4250m of FIG. 21.

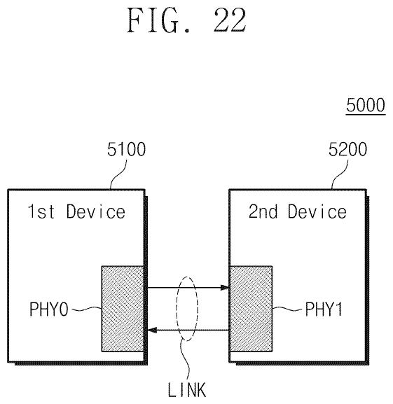

FIG. 22 is a block diagram illustrating an electronic system according to some example embodiments. Referring to FIG. 22, an electronic system 5000 may include a first device 5100 and a second device 5200. The first and second devices 5100 and 5200 may be individual devices configured to perform various functions, for example, hardware, one or more of a function block, an intellectual property (IP) block, etc. Alternatively or additionally, the first device 5100 may be, may include, or may be included in a processor and/or a controller configured to control the second device 5200. Alternatively or additionally, the second device 5200 may be, may include, or may be included in a processor and/or a controller configured to control the first device 5100.

In some example embodiments, the first device 5100 may be, may include, or may be included in a universal flash storage (UFS) host, and the second device 5200 may be a UFS device. Alternatively or additionally, the first device 5100 may be a CPU, and the second device 5200 may include at least one of various devices configured to communicate with the CPU, for example, one or more of a CPU, a modem, a main memory, an input device, etc.

The first device 5100 may include the 0-th physical layer PHY0, and the second device 5200 may include the first physical layer PHY1. The 0-th and first physical layers PHY0 and PHY1 may be connected to each other through a link for serial communication. In some example embodiments, each of the 0-th and first physical layers PHY0 and PHY1 may support the serial communication defined by the PCIe standard. However, example embodiments are not limited thereto. For example, the 0-th and first physical layers PHY0 and PHY1 may be configured to support various serial communications such as MIPI and M-PHY.

In some example embodiments, the second device 5200 may adjust a setting value or an amplification gain of the receiver included in the first physical layer PHY1 of the second device 5200 depending on a temperature change of the second device 5200. For example, based on the operation method described with reference to FIGS. 1 to 12, the second device 5200 may adjust the setting value or the amplification gain of the receiver included in the first physical layer PHY1.

In some example embodiments, the first device 5100 may perform the training operation on the 0-th and first physical layers PHY0 and PHY1 depending on the temperature change of the second device 5200. For example, the first device 5100 may optimize the receiver of the second device 5200 by performing the training operation on the 0-th and first physical layers PHY0 and PHY1 based on the operation method described with reference to FIGS. 13 to 17.

As described above, according to some example embodiments, a receiver of a storage device may be improved or optimized depending on a temperature of the storage device. Accordingly, the decrease in the effective margin of the receiver according to the temperature change of the storage device may be prevented or reduced in likelihood of occurrence and/or of impact in occurrence. A host may communicate with a plurality of storage devices, and a receiver of each of the plurality of storage devices may be individually improved or optimized depending on a temperature of each of the plurality of storage devices. Accordingly, a storage device with improved performance and improved reliability and a storage system are provided.

According to some example embodiments, various setting values of a receiver included in a physical layer of a storage device may be adjusted depending on a temperature of the storage device. In this case, the receiver may be improved or optimized depending on the temperature of the storage device, or the effective margin of the receiver may be secured depending on the temperature of the storage device. Accordingly, a storage device with improved performance, an operation method of the storage device, and a storage system including the storage device are provided.

Various blocks and/or elements described in the above figures may communicate with other various blocks and/or elements described in the above figures. The communication may be in a one-way manner, and/or a two-way manner, and/or a multi-way manner (such as a broadcast manner). Alternatively or additionally, the communication may be over a bus, such as but not limited to a wireless bus and/or a wired bus. In some example embodiments, the communication may include information such as but not limited to data and/or commands, and the communication may be sent and/or received digitally and/or in analog manner. In some cases, the communication may be sent and/or received in a serial and/or a parallel manner; example embodiments are not limited thereto.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

According to some example embodiments, a storage system may include a host device;
a first storage device including a first receiver configured to receive a first transmit signal from the host device through a first signal line; and a second storage device including a second receiver configured to receive a second transmit signal from the host device through a second signal line, and the host device is configured to: in response to a first temperature of the first storage device exceeding a reference temperature, perform first link retraining on the first storage device to adjust a first setting value of the first receiver to an adjusted first setting value; and in response to a second temperature of the second storage device exceeding the reference temperature, perform second link retraining on the second storage device to adjust a second setting value of the second receiver to an adjusted second setting value.

In an embodiment, the first temperature is different from the second temperature, and
the adjusted first setting value is different from the adjusted second setting value.

In an embodiment, the storage system is configured to perform initialization on each of the first and second storage devices, the storage system is configured to set the first receiver of the first storage device based on a first default setting value through the initialization, the storage system is configured to set the second receiver of the second storage device based on a second default setting value through the initialization, the adjusted first setting value is different from the first default setting value, and the adjusted second setting value is different from the second default setting value.

In an embodiment, the first setting value includes a setting value of at least one of a first continuous time linear equalizer, a first variable gain amplifier, and a first decision feedback equalizer included in the first receiver, and the second setting value includes a setting value of at least one of a second continuous time linear equalizer, a second variable gain amplifier, and a second decision feedback equalizer included in the second receiver.

While some example embodiments have been described with reference to embodiments thereof, it will be apparent to those of ordinary skill in the art that various changes and modifications may be made thereto without departing from the spirit and scope of the present disclosure as set forth in the following claims. Additionally, example embodiments are not necessarily mutually exclusive with one another. For example, some example embodiments may include one or more features described with reference to one or more figures, and may also include one or more other features described with reference to one or more other figures.

1. A storage device comprising:
a nonvolatile memory device; and
a storage controller configured to control the nonvolatile memory device,
wherein the storage controller includes,
a receiver configured to receive a receive signal from an external device through a first signal line,
a temperature sensor configured to sense a temperature of the storage device and to output temperature information, and
receiver control logic configured to adjust a setting value of the receiver to an adjusted setting value, based on the temperature information.

2. The storage device of claim 1, wherein the receiver includes:
a continuous time linear equalizer configured to receive the receive signal through the first signal line and to perform a high-pass filtering operation on the receive signal;
a variable gain amplifier configured to amplify an output of the continuous time linear equalizer; and
a decision feedback equalizer configured to perform sampling based on an output of the variable gain amplifier.

3. The storage device of claim 2, wherein the receiver further includes:
a deserializer configured to deserialize an output of the decision feedback equalizer.

4. The storage device of claim 2, wherein
the setting value of the receiver includes an amplification gain value associated with an amplification gain of the variable gain amplifier, and
the receiver control logic is configured to adjust the amplification gain of the variable gain amplifier, based on the temperature information.

5. The storage device of claim 4, wherein, as the temperature of the storage device corresponding to the temperature information increases, the amplification gain of the variable gain amplifier increases.

6. The storage device of claim 4, wherein,
in response to the temperature of the storage device corresponding to the temperature information being included in a first temperature range, the receiver control logic is configured to adjust the amplification gain of the variable gain amplifier to a first value, and
in response to the temperature of the storage device corresponding to the temperature information being included in a second temperature range different from the first temperature range, the receiver control logic is configured to adjust the amplification gain of the variable gain amplifier to a second value different from the first value.

7. The storage device of claim 4, wherein the receiver control logic is configured to
adjust the amplification gain of the variable gain amplifier to a first value and to measure a first margin based on the output of the variable gain amplifier,
adjust the amplification gain of the variable gain amplifier to a second value and to measure a second margin based on the output of the variable gain amplifier, and
to adjust one of the first and second values to a good amplification gain of the variable gain amplifier based on the first margin and the second margin.

8. The storage device of claim 2, wherein the setting value of the receiver includes a continuous time linear equalizer setting value associated with the continuous time linear equalizer and a decision feedback equalizer setting value associated with the decision feedback equalizer.

9. The storage device of claim 1, wherein,
in an initialization operation of the storage device, the receiver is configured to be set based on a default setting value, and
the adjusted setting value is different from the default setting value.

10. The storage device of claim 9, wherein,
in response to the storage device being hot-reset, the receiver control logic is configured to store the adjusted setting value of the receiver in the nonvolatile memory device, and
wherein, in response to the storage device being cold-reset, the receiver control logic is configured to clear the adjusted setting value of the receiver.

11. The storage device of claim 10, wherein,
in response to booting being made after the hot-reset, the receiver control logic is configured to set the receiver based on the adjusted setting value stored in the nonvolatile memory device, and
in response to booting being made after the cold-reset, the receiver control logic is configured to set the receiver based on the default setting value.

12. The storage device of claim 1, wherein the storage controller further includes:
a transmitter configured to output a transmit signal to the external device through a second signal line.

13. An operation method of a storage device, the method comprising:
setting a receiver with a default setting value, wherein the receiver is configured to receive a receive signal from an external device through a first signal line;
monitoring a temperature of the storage device; and
in response to the temperature of the storage device being greater than or equal to a reference value, adjusting a setting value of the receiver to an adjusted setting value.

14. The method of claim 13, wherein the receiver includes:
a continuous time linear equalizer configured to receive the receive signal through the first signal line and to perform a high-pass filtering operation on the receive signal;
a variable gain amplifier configured to amplify an output of the continuous time linear equalizer; and
a decision feedback equalizer configured to perform sampling based on an output of the variable gain amplifier, and
wherein the adjusted setting value of the receiver includes an amplification gain value associated with an amplification gain of the variable gain amplifier.

15. The method of claim 14, wherein the adjusted setting value of the receiver includes a continuous time linear equalizer setting value associated with the continuous time linear equalizer and a decision feedback equalizer setting value associated with the decision feedback equalizer.

16. The method of claim 13, wherein
the adjusting of the setting value of the receiver in response to the temperature of the storage device being greater than or equal to the reference value includes:
performing link retraining in response to a request of the external device.

17. The method of claim 16, wherein the link retraining includes:
optimizing a downstream lane between the receiver of the storage device and a transmitter of the external device.

18. A storage device comprising:
a nonvolatile memory device; and
a storage controller configured to control the nonvolatile memory device,
wherein the storage controller is configured to configure a receiver, which is configured to receive a receive signal from an external device, with a default setting value through initialization with the external device, and
wherein, in response to a temperature of the storage device exceeding a reference temperature, the storage controller is configured to re-configure the receiver based on a first setting value corresponding to the temperature of the storage device.

19. The storage device of claim 18, wherein the receiver includes:
a continuous time linear equalizer configured to receive the receive signal through a first signal line and to perform a high-pass filtering operation on the receive signal;
a variable gain amplifier configured to amplify an output of the continuous time linear equalizer; and
a decision feedback equalizer configured to perform sampling based on an output of the variable gain amplifier, and
wherein the first setting value includes an amplification gain value associated with an amplification gain of the variable gain amplifier.

20. The storage device of claim 19, wherein the first setting value further includes a continuous time linear equalizer setting value associated with the continuous time linear equalizer and a decision feedback equalizer setting value associated with the decision feedback equalizer.

21.-24. (canceled)
